(19) United States
(12) Patent Application Publication
(10) Pub. No.: US 2023/0312342 A1
(43) Pub. Date: Oct. 5, 2023

(54) Method of preparation of zinc-oxygen-based nanoparticles, zinc peroxide nanoparticles obtained by this method and their use

(71) Applicant: NANOXO SP. Z O.O., Warsaw (PL)

(72) Inventors: Malgorzata WOLSKA-PIETKIEWICZ, Warsaw (PL); Maria JEDRZEJEWSKA, Warsaw (PL); Emil BOJARSKI, Warsaw (PL); Janusz LEWINSKI, Josefow (PL)

(21) Appl. No.: 18/005,675

(22) PCT Filed: Jul. 16, 2021
(86) PCT No.: PCT/PL2021/050054

§ 371 Date: Jan. 17, 2023

(30) Foreign Application Priority Data
Jul. 17, 2020 (PL) P.434715

(51) Int. Cl. C01B 15/047; C01G 9/02

(52) U.S. Cl. CPC C01B 15/047; C01G 9/02; C01P 2002/72; C01P 2002/82; C01P 2002/88; C01P 2004/04; C01P 2004/51; C01P 2004/64; C01P 2006/80

(57) ABSTRACT

The subject matter of the invention is a method of preparation of zinc-oxygen-based nanoparticles, in which the organozinc precursor is treated with an oxidizing agent, wherein the organozinc precursor is a compound of the formula (R)ₙ(Zn)ₘ(L)_{y}(X)_{z}, where: R is straight, branched or cyclic C1-C10 alkyl group or straight, branched or cyclic C1-C10 alkenyl group, benzyl group, phenyl group, mesityl group, in which any hydrogen atom may be substituted with fluorine, chlorine, bromine or iodine atom; L is neutral donor organic ligand selected from the group of organic compounds including amine, phosphine, phosphine oxide, sulfoxide, ketone, amide, imine, ether, urea and its organic derivatives, aminosilane or perfluorinated derivatives thereof, or mixtures thereof; X is monoanionic organic ligand derived from the organic compound X-H, where H is a hydrogen atom with acidic properties and the compound X-H is carboxylic acid, amide, amine, imide, alcohol, mono- or diester of phosphoric acid, organic derivatives of phosphinic or phosphonic acid, phenol, mercaptan, hydroxy acid, amino acid, hydroxy amide, amino amide, hydroxy ester, amino ester, hydroxy ketone, amino ketone, urea and its organic derivatives, silanol, aminosilane, mercaptosilane and organic derivatives of alkoxysilane or perfluorinated derivatives thereof, or mixtures thereof; m and n are integers from 1 to 10; y and z are integers from 0 to 10, wherein the oxidizing agent is hydrogen peroxide, peracetic acid or ozone, and the organozinc precursor is treated with the oxidizing agent under an inert gas atmosphere.

The invention also relates to zinc peroxide nanoparticles prepared by the above-defined method and their use as antibacterial and bacteriostatic materials, as a component of pyrotechnic compositions, photocatalyst, and single-source inorganic precursors of nanoparticulate forms of zinc oxide (ZnO).

The subject matter of the invention is a method of preparation of zinc-oxygen-based nanoparticles, zinc peroxide nanoparticles (ZnO₂ NPs) without the addition of any stabilizing agent or zinc peroxide nanoparticles coated with an organic shell composed of anionic or neutral ligands, or mixtures thereof obtained by the said method as well as their use.

Zinc peroxide (ZnO₂) is a white or slightly yellowish, odorless semiconductor material (E_{g} = 3,3 - 4,6 eV^{[1,2]}) with properties described as transition between ionic and covalent-type compounds.^{[3]} This inorganic compound from the group of peroxides exhibits powerful oxidizing properties and the ability to generate free radicals and/or other reactive oxygen species. Zinc peroxide crystallizes in the cubic Pa3 space group. The crystal structure of ZnO₂ is characterized by irregular octahedrons with a central Zn²⁺ ion surrounded by O ions located at the vertices of these polyhedrons. The distance between the two oxygen atoms is 1.47 Å, which is 0.64 Å shorter than the Zn—O bond length (2.11 Å).^{[4]} This structure implies the occurrence of local charge balance disturbances in the ZnO₂ crystal lattice and causes structural instability of this material to, for example, high temperature (which explains the relatively low temperature of decomposition of ZnO₂ into ZnO^{[1,5,6]}), and sensitivity to the pH changes in the solution.^{[7]}

The above-described electronic and structural characteristics of ZnO₂ make it a promising material for various industrial applications and, constantly supplemented with further discoveries, constitute the basis for new implementations and technologies. This material is used in the rubber and plastics processing industry,^{[8]} in cosmetics, pharmaceutical and medical industries (among others as antiseptic^{[9,10]} and antibacterial^{[7,11,12]} agent as well as wound healing aid^{[13]} or a new type of nanotherapeutic^{[14,15]}), and as a component of pyrotechnic compositions,^{[16]} and even as an agent for removing pollutants from the water^{[17-19]} as well as for neutralizing combat gases.^{[20]} In addition, ZnO₂ nanostructures are also used as efficient photocatalysts,^{[21-23]} materials for the construction of sensors^{[24]} or electronic devices,^{[25]} reagents in the oxidation of organic compounds^{[26-29]} as well as single-source inorganic precursors of nanoparticulate forms of ZnO.^{[5,30,31]}

A zinc peroxide compound was first obtained by L. Tenar in 1818.^{[32]} There are several methods of synthesis of zinc peroxide nanostructures that are currently commonly known and used, among which we can distinguish two main groups: physical methods allowing for the production of thin layers or thin films (e.g., electrolytic deposition^{[6]} and pulsed laser ablation (PLA)^{[33]}) and chemical methods, which due to the nature of the applied precursor can be divided into procedures using inorganic or organometallic precursors.^{[1,34]} The main assumption of the commonly used wet-inorganic methods is the preparation of macroscopic and/or nanocrystalline ZnO₂ as a result of the direct reaction between selected precursor (i.e., Zn,^{[35,36]} ZnO,^{[2,23,27,35-39]} Zn(OH)₂,^{[30,42]} Zn(OOCCH₃)₂,^{[4,5,}^{7,}¹¹^{,}¹³⁻¹⁵^{,}¹⁷^{,}²⁴^{,}²⁶^{,43-58]} ZnSO₄,^{[3,21,22,43]} Zn(NO₃)₂,^{[43]} ZnCl₂,^{[}²⁰^{,}^{32,43]} Zn₅(CO₃)₂(OH)₆,^{[59,60]} zinc carbamate of the formula Zn(OCONHC₄H₉)₂^{[61]}) and hydrogen peroxide (in the form of hydrogen peroxide aqueous solutions at concentration of 3% or 30%, or ammonia hydroxide solution). This process is usually carried out at elevated temperature (in the temperature range from ca. 60° C.^{[11,48]} to 150° C.^{[2,23]}) or in the presence of supporting agents such as the catalytic amount of acetic acid,^{[35]} irradiation^{[11,24,44,48-50]} or ultrasounds.^{[11]} Among the chemical methods based on inorganic precursors, we can distinguish, for example, precipitation method,^{[13,}²⁰^{,}²³^{,}^{32]} colloidal synthesis,^{[52]} hydrothermal route,^{[4,5,26,46,47]} microemulsion method,^{[62]} oxidation-hydrolysis-precipitation procedure,^{[45]} sol-gel process,^{[11,}^{44]} reaction using high-pressure impinging-jet reactor^{[7,57]} or “green synthesis” based on Leidenfrost phenomenon.^{[58]} An interesting example of a chemical method for the preparation of ZnO₂ thin films is the successive ionic layer adsorption and reaction technique (SILAR method^{[63]}). In a few cases, the authors attempted to stabilize the surface of a nanocrystalline product with the use of low- (e.g., glucose-1-phosphate,^{[57]} 2-(methacryloyloxy)ethyl phosphate^{[7]}) or high-molecular-weight (e.g., polyethylene glycol - PEG,^{[45,61]} sodium polyphosphate,^{[32]} polyvinylpyrrolidone- PVP^{[15,61]}) organic compounds acting as surfactants. The main goal of such treatments is the preparation of homogeneous nanostructures, improving their stability, and, in the case of bi- or multifunctional compounds, the possibility of post-synthetic surface modification. The type and the quantity of the additional stabilizing agent affect, among others, the yield of the reaction, the degree of precursor conversion, as well as composition, structure, morphology, and oxidizing properties of the final product.^{[7,57]} For example, using an additional long-chain stabilizer - PEG200 - in the inorganic synthesis leads to the formation of aggregated ZnO₂ nanoparticles with a core size of ca. 10 nm, which decompose into ZnO at 233° C.^{[45]} Moreover, the size and the stability of the ZnO₂ NPs dispersion are strongly related to the type and the concentration of the applied polymer; in the case of a polymer with a higher molecular weight, it is possible to obtain ZnO₂ nanoparticles with a smaller core size and a narrow size distribution.^{[61]}

The use of submicron ZnO powder as a precursor in the synthesis of ZnO₂ leads to the formation of structures that differ in terms of morphology, i.e., from nanometric objects (5 -18 nm)^{[2,27]} to bigger (100 - 200 nm) microspheres,^{[37]} crystallites with a size of ca. 1 µm^{[41]} or polycrystalline layers^{[38-40]} of zinc peroxide. However, the purity of the resulting material depends on the temperature of the process. Too low (ca. 50° C.) or too high (> 150° C.) temperature leads to a mixture of ZnO and ZnO₂ phases, which is not desirable in the context of obtaining homogeneous and high purity nanomaterials.^{[2]} Most of the above-mentioned inorganic processes also suffer from a low degree of crystallinity and impurities in the final material, e.g., in the form of an unreacted precursor and/or other reactants^{[4,44]} or the presence of a Zn(OH)₂ by-product.^{[2,4]} It has also been proven that the physicochemical properties of the final material depend on both the applied method and conditions of the reaction between selected precursor and hydrogen peroxide; reaction rate depends on factors such as temperature, time, pressure, amount and type of solvent, type of the applied precursor, presence and nature of the stabilizing agent, and concentration of the H₂O₂ solution. Among the inorganic methods, we can also distinguish the mechanochemical approach (i.e., solvent-free) based on grinding of zinc acetate in a ball mill with the addition of a H₂O₂ aqueous solution of 20% and repeating this operation several times until the product in the form of zinc peroxide is obtained.^{[54]} All of the mentioned synthetic methods lead to the formation of nanostructured materials of irregular shape,^{[2,45,52]} which tend to aggregate and/or agglomerate and thus afford heterogeneous materials with high polydispersity and moderate stability.^{[2,5,11,17,20,23,26,28,33,45,46,52-57]}

An alternative to the above-described methods for the preparation of ZnO₂ is an organometallic approach. The first reference in the literature to the utility of organozinc compounds relates to the fabrication of macroscopic-type ZnO₂ hydrate from Et₂Zn.^{[34]} On the other hand, nanoparticles with paramagnetic properties and characterized by homogeneity and small size (ca. 3 nm) can be obtained from the in situ generated precursor from the mixture of octylamine, ZnCl₂, and RMgCl.^{[1,64]} However, the mentioned method did not allow for the preparation of nanoparticulate forms of ZnO₂ with a well-defined structure and coated with a wide spectrum of organic ligands (i.e., anionic X-type ligands, neutral L-type ligands and their mixtures).

Due to the fact that the properties of ZnO₂ strongly depend on the applied synthetic procedure, effective methods of preparation of nanocrystalline zinc peroxide with desired properties and physicochemical parameters are still being sought. Moreover, the developed technologies should be characterized by the synthetic procedure’s high repeatability, reproducibility, and simplicity.

Zinc oxide (ZnO) belongs to the group of II-VI fluorescent semiconductors and exhibits interesting physicochemical properties. The energy gap of this material at room temperature is 3.37 eV and the exciton bond energy is ca. 60 meV, which makes this material similar to the commonly used in optoelectronics gallium nitride (GaN).^{[65]} There are a number of methods for the synthesis of nanocrystalline ZnO, among which we can distinguish physical processes and chemical methods. Due to the nature of the applied precursor, chemical methods can be divided into procedures using inorganic (i.e., simple zinc salts) and organometallic (i.e., dialkyl^{[67]} and alkylzinc^{[68,69]} compounds) precursors. Typical inorganic methods (e.g., sol-gel process and precipitation methods) lead to the formation of ZnO nanoparticles (NPs) characterized by significant heterogeneity and relatively wide size distribution, which may also be contaminated with alkali metal ions and/or ionic-type by-products. In addition, the properties of the resulting nanoparticles depend on the applied process conditions, such as temperature, type of solvent, concentration and pH.^{[66]} The organometallic approach is based on reactions between organozinc compounds and oxygen or water, which are usually very fast and strongly exothermic. Both the appropriate process conditions (low concentrations and reduced temperature) and the usage of stabilizing ligands, which reduce the reactivity of the organometallic compound and finally stabilize the surface of the resulting ZnO nanostructures, could control these reactions.

A competitive method to the above-mentioned synthetic procedures, in which inorganic or organozinc precursor is only a source of Zn, while O atoms are delivered in the form of hydroxide, O₂ and/or H₂O (i.e., by slow diffusion of water and oxygen from the air, controlled introduction of water in the form of solutions in organic solvents or together with a stabilizing ligand) is the use of the so-called single-source precursors, which contain all the elements of the synthesized nanomaterial in their molecular structure.^{[70]} Examples of such precursors are, for example, alkyl(alkoxy)zinc compounds^{[70a-c]} and alkyl(hydroxy)zinc compounds.^{[70d]} An alternative is also the use of ZnO₂ as a single-source precursor of nanoparticulate forms of ZnO,^{[5,30,31]} however, there are no methods of fabrication of homogeneous ZnO₂ nanostructures of appropriate quality, which then would allow for the production of homogeneous ZnO nanoparticles.

The subject matter of the invention is a method of preparation of zinc-oxygen-based nanoparticles, in which an organozinc precursor is treated with an oxidizing agent, wherein the organozinc precursor is a compound of the formula

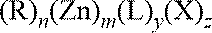

where:
R is straight, branched or cyclic C1-C10 alkyl group or straight, branched or cyclic C1-C10 alkenyl group, benzyl group, phenyl group, mesityl group, in which any hydrogen atom may be substituted with fluorine, chlorine, bromine or iodine atom;
L is neutral donor organic ligand selected from the group of organic compounds including amine, phosphine, phosphine oxide, sulfoxide, ketone, amide, imine, ether, urea and its organic derivatives, aminosilane or perfluorinated derivatives thereof, or mixtures thereof;
X is monoanionic organic ligand derived from the organic compound X-H, where H is a hydrogen atom with acidic properties and the compound X-H is carboxylic acid, amide, amine, imide, alcohol, mono- or diester of phosphoric acid, organic derivatives of phosphinic or phosphonic acid, phenol, mercaptan, hydroxy acid, amino acid, hydroxy amide, amino amide, hydroxy ester, amino ester, hydroxy ketone, amino ketone, urea and its organic derivatives, silanol, aminosilane, mercaptosilane and organic derivatives of alkoxysilane or perfluorinated derivatives thereof, or mixtures thereof;
m and n are integers from 1 to 10;
y and z are integers from 0 to 10;
wherein the oxidizing agent is hydrogen peroxide, peracetic acid or ozone, and the organozinc precursor is treated with the oxidizing agent under an inert gas atmosphere.

Preferably achiral, optically active or organic compounds with an additional positive charge located at the nitrogen (N), phosphorus (P) or sulfur (S) atom are used as L- and X-type ligands.

Preferably the method of the invention leads to the preparation of zinc peroxide (ZnO₂) nanoparticles or zinc oxide (ZnO) nanoparticles, more preferably zinc peroxide (ZnO₂) nanoparticles.

Preferably the method of the invention leads to the preparation of uncoated zinc-oxygen-based nanoparticles and zinc-oxygen-based nanoparticles coated with an organic shell composed of at least one organic ligand, more preferably composed of two or more organic ligands selected from X and L, wherein X and L are defined above.

Preferably zinc-oxygen-based nanoparticles with a diameter less than or equal to 5 nm are prepared.

Preferably dialkyl- or diarylzinc compound of the formula R₂Zn, where R is straight, branched or cyclic C1-C10 alkyl group or straight, branched or cyclic C1-C10 alkenyl group, benzyl group, phenyl group, mesityl group, in which any hydrogen atom may be substituted with fluorine, chlorine, bromine or iodine atom is used as organozinc precursor.

Also preferably the organozinc precursor is a compound produced by the reaction between dialkyl- or diarylzinc compound of the formula R₂Zn and an organic L- or X-H-type compound, or a mixture of two or more of these compounds, wherein:
R is straight, branched or cyclic C1-C10 alkyl group or straight, branched or cyclic C1-C10 alkenyl group, benzyl group, phenyl group, mesityl group, in which any hydrogen atom may be substituted with fluorine, chlorine, bromine or iodine atom; and
L is amine, phosphine, phosphine oxide, sulfoxide, ketone, amide, imine, ether, urea and its organic derivatives, aminosilane or perfluorinated derivatives thereof, or mixtures thereof;
X-H is carboxylic acid, amide, amine, imide, alcohol, mono- or diester of phosphoric acid, organic derivatives of phosphinic or phosphonic acid, phenol, mercaptan, hydroxy acid, amino acid, hydroxy amide, amino amide, hydroxy ester, amino ester, hydroxy ketone, amino ketone, urea and its organic derivatives, silanol, aminosilane, mercaptosilane and organic derivatives of alkoxysilane or perfluorinated derivatives thereof, or mixtures thereof.

Preferably the organozinc precursor formed by the reaction between a dialkyl- or diarylzinc compound of the formula R₂Zn and an organic L- or X-H-type compound, or a mixture of two or more of these compounds, is generated in situ.

Preferably the in situ generated organozinc precursor is stored under an inert gas atmosphere for 0 minutes to 48 hours prior to exposure to the oxidizing agent.

Preferably a homoligand precursor or a heteroligand precursor, or mixtures thereof is used as organozinc precursor.

Preferably a pure solid-state compound or its solution in an aprotic organic solvent is used as dialkyl- or diarylzinc compound.

Preferably diethylzinc, dimethylzinc, di-iso-propylzinc, di-tert-buthylzinc, dicyclopentylzinc, dicyclohexylzinc or dicyclopentadienylzinc is used as dialkylzinc compound.

Preferably diphenylzinc or bis(pentafluorophenyl)zinc is used as diarylzinc compound.

Preferably a compound belonging to the purity category ranges from technical purity (90 - 99%) to spectral purity (99.999 - 99.9999%) is used as dialkyl- or diarylzinc compound.

Preferably hydrogen peroxide in the form of an aqueous solution or in the form of solid-state peroxide adducts is used as oxidizing agent.

Preferably hydrogen peroxide is used in the form of the aqueous solution at a concentration in the range from 1 to 75%, more preferably at a concentration in the range from 3 to 30%, and the most preferably at the concentration of 30%.

Preferably hydrogen peroxide-urea adduct (CO(NH₂)₂·H₂O₂) or sodium percarbonate (Na₂CO₃·1.5H₂O₂) is used as peroxide adduct.

Preferably ozone is supplied from the ozone generator, which produces it at a capacity in the range from 0.1 g/h to 50 g/h.

Preferably a molar ratio of the organozinc precursor to the oxidizing agent ranges from 1: 1 to 1:4, more preferably 1: 1, is used.

Preferably the method of the invention is carried out at temperature in the range from -78° C. to 70° C., more preferably in the range from -78° C. to 40° C.

Preferably the method of the invention is carried out for 5 seconds to 25 hours.

Preferably the method of the invention is carried out by treating the organozinc precursor with the oxidizing agent at a temperature in the range from -78° C. to 30° C. for 5 seconds to 1 hour and followed by heating the reaction mixture to a temperature in the range from 10° C. to 70° C. and then the reaction is continued for 15 minutes to 24 hours.

Preferably the organozinc precursor is treated with the oxidizing agent in an aprotic organic solvent.

Preferably anhydrous or water-containing solvent is used as aprotic organic solvent.

Preferably concentration of water in the solvent is less than 0.5%.

Preferably tetrahydrofuran, toluene, xylene, benzene, dimethylsulfoxide, dichloromethane, dioxane, acetonitrile, chloroform, hexane, acetone, diethyl ether or mixtures thereof are used as aprotic organic solvent.

Preferably molar concentration of the organozinc precursor in the reaction mixture ranges from 0.01 mol/L to 0.5 mol/L.

Preferably when using solid-state reactants, the method of the invention is carried out by a mechanochemical, i.e., solvent-free approach, preferably by grinding the organozinc precursor and the oxidizing agent in a glass reactor, in a mortar or in a ball mill.

Preferably the solvent-free approach comprises adding a dispersing agent.

Preferably an organic solvent which does not dissolve both the organozinc precursor and the oxidizing agent is added as the dispersing agent, more preferably hexane, dimethylsulfoxide, toluene, dioxane or mixtures thereof is used.

Preferably the method of the invention comprises at least one washing step of the as-prepared zinc-oxygen-based nanoparticles using an organic solvent to remove an excess of organic ligand as well as in order to obtain high-quality material, more preferably the washing step is performed twice.

Preferably hexane, ethanol, methanol, acetone, toluene, benzene, xylene, tetrahydrofuran, dioxane, diethyl ether, dichloromethane or mixtures thereof is the organic solvent used in the washing step.

Preferably the method of the invention comprises one of the additional post-processing steps selected from:
grinding the as-prepared zinc peroxide nanoparticles;
annealing of the as-prepared zinc peroxide nanoparticles; or
dispersing the as-prepared zinc peroxide nanoparticles in solutions with a pH less than or equal to 7.5 and stored them in the resulting solution.

Preferably grinding of ZnO₂ is carried out under anaerobic or aerobic conditions.

Preferably grinding of ZnO₂ is carried out in a glass reactor, in a ball mill or in a mortar, more preferably in a ball mill at a vibration frequency from 15 Hz to 30 Hz.

Preferably annealing is carried out under anaerobic or aerobic conditions.

Preferably annealing is carried out at a temperature in the range from 100° C. to 1000° C. for 1 minute to 48 hours.

The invention also relates to zinc peroxide nanoparticles prepared by the above-defined method.

Preferably zinc peroxide nanoparticles are uncoated or coated with an organic shell.

Preferably the organic shell is composed of at least one organic ligand selected from X and L, wherein
L is neutral donor organic ligand selected from the group of organic compounds including amine, phosphine, phosphine oxide, sulfoxide, ketone, amide, imine, ether, urea and its organic derivatives, aminosilane or perfluorinated derivatives thereof, or mixtures thereof;
X is monoanionic organic ligand derived from the organic compound X-H, where H is a hydrogen atom with acidic properties and the compound X-H is carboxylic acid, amide, amine, imide, alcohol, mono- or diester of phosphoric acid, organic derivatives of phosphinic or phosphonic acid, phenol, mercaptan, hydroxy acid, amino acid, hydroxy amide, amino amide, hydroxy ester, amino ester, hydroxy ketone, amino ketone, urea and its organic derivatives, silanol, aminosilane, mercaptosilane and organic derivatives of alkoxysilane or perfluorinated derivatives thereof, or mixtures thereof.

Preferably L- and X-type ligands are selected from achiral, optically active or organic compounds with an additional positive charge located at the nitrogen (N), phosphorus (P) or sulfur (S) atom.

Preferably the organic shell is composed of at least one organic ligand selected from X and L, wherein X and L are defined as above.

Preferably the diameter of zinc peroxide nanoparticles is less than or equal to 5 nm.

The invention also relates to the use of above-defined zinc peroxide nanoparticles as antibacterial and bacteriostatic materials, as a component of pyrotechnic compositions, photocatalyst, and single-source inorganic precursors of nanoparticulate forms of zinc oxide (ZnO).

The method of the invention leads to the preparation of zinc-oxygen-based nanoparticles without the addition of any stabilizing agent or zinc-oxygen-based nanoparticles coated with an organic shell composed of anionic X-type, neutral L-type ligands or mixtures thereof, characterized by high purity and crystallinity, stability, uniformity in shape and size. Preferably, the method of the invention leads to the formation of zinc peroxide nanoparticles; however, it is also possible to obtain nanocrystalline ZnO directly (i.e., by using an appropriate source of H₂O₂ and/or the molar ratio of the applied reactants) or indirectly (by a transformation of the resulting peroxide materials). The use of suitable, well-defined organozinc precursors and the use of hitherto not considered organic and inorganic peroxide adducts made it possible to solve the problems associated with the synthetic processes described in the prior art.

In the method of the invention dialkyl- ir diarylzinc compounds of the formula R₂Zn as well as organometallic R₂ZnL_{y}— and RZnX-type compounds were used, which may occur in a monomeric or an aggregated form. The applied R₂ZnL_{y}-type precursors contain in their structure R₂Zn species, which are stabilized by neutral aprotic ligands. In turn, the [RZnX]-type precursors may be considered as homo- or heteroligand complexes obtained in the direct reaction of the compound X-H with dialkyl- or diarylzincs, which lead to the formation of nanoparticles stabilized with one- or multi-component organic shell. The method of the invention makes it possible to obtain the following types of nanocrystalline ZnO₂ with a core size within a few nanometers (from 1 nm to 10 nm): i) uncoated nanoparticles, i.e., without the addition of surface stabilizing agents; ii) nanoparticles coated with organic L-type ligands; also including ligands derived from the applied peroxide adducts; iii) nanoparticles coated with monoanionic X-type organic ligands; iv) mixed-ligand shell nanoparticles, i.e., nanoparticles stabilized with a multi-component organic shell composed of two or more types of ligands (e.g. X+L) or composed of two or more different ligands of the same type (e.g., X1+X2, L1+L2). It also allows for the determination of relationship between the properties of the resulting nanoparticles and their structure as well as significantly facilitates the design of new nanomaterials with a defined structure and desired physicochemical properties. In addition, the use of anionic ligands allows for better control of nanoparticle growth. In the above-described systems, the anionic X-type ligands and the neutral L-type ligands are connected to the zinc-oxygen-based core by strong covalent or donor-acceptor bonds, respectively. As a result, a better stabilization of the nanocrystalline ZnO₂ core and thus increased stability as well as limited aggregation and/or agglomeration of the resulting nanoparticles is provided. It is worth noting that the literature-derived data indicated that the stabilization of the cores and the degree of aggregation of the nanoparticles prepared using low- or high-molecular-weight surfactants occurs through weaker and more labile interactions, which results in irregularly shaped nanoparticles with moderate stability, high polydispersity and tendency to aggregation and/or agglomeration. ZnO₂ NPs are a promising material used as a solid-state oxygen reservoir as well as a source of reactive oxygen species in both solid-state and in solution. The resulting ZnO₂ nanoparticles could also be used as antibacterial and bacteriostatic materials, as a component of pyrotechnic compositions, photocatalyst, and single-source inorganic precursors of nanoparticulate forms of zinc oxide. An appropriate selection of the process conditions (i.e., annealing temperature, vibration frequency of grinding and pH) allows for a controlled decomposition of the peroxide bond and transformation into uniform in shape and size zinc oxide nanoparticles. The method of the invention also allows to obtaining nanocrystalline ZnO by the direct method, i.e., by reacting an organometallic precursor with ozone or by using an appropriate molar ratio of the organozinc compound to the oxidizing agent in the form of inorganic peroxide adduct. Nanocrystalline ZnO can also be obtained using a reaction medium with coordinating properties in a direct reaction between dialkylzinc compound and H₂O₂.

The method of the invention opens up new possibilities in the design and the synthesis of new zinc-oxygen-based functional nanomaterials based on ZnO₂ or ZnO.

The results concerning zinc-oxygen-based nanoparticles prepared by the method of the invention are shown in the figure, where:

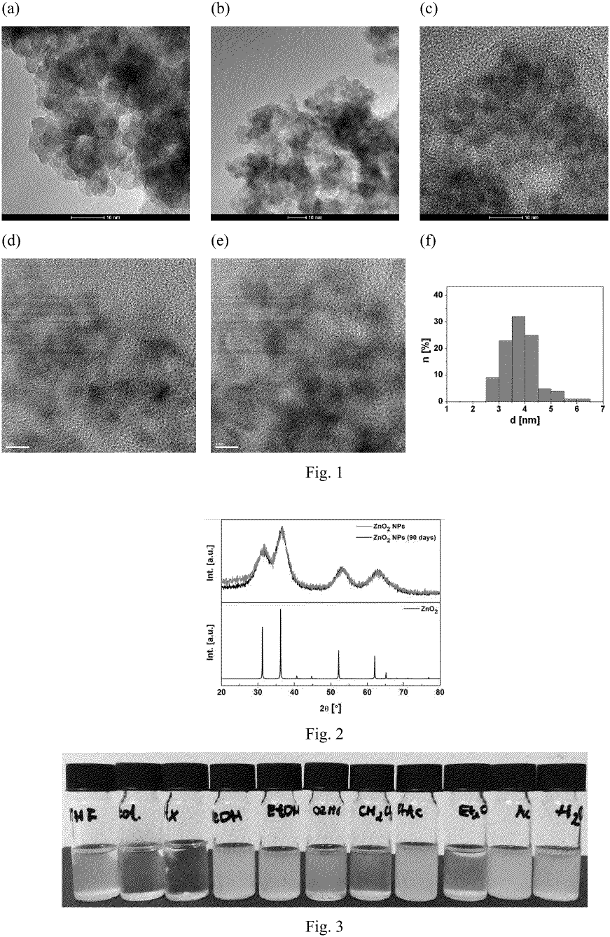

FIGS. 1(a - e) shows selected TEM micrographs of ZnO₂(1) NPs, and FIG. 1(f) shows size distribution of the resulting nanoparticles; symbols used in the drawing: n - counts, d - core diameter of the NPs (Example 1).

FIG. 2 shows powder X-ray diffraction pattern of ZnO₂(1) NPs together with a reference bulk ZnO₂ pattern (macroscopic material) recorded immediately after the synthesis (dark gray line) and after 90 days of storage (light gray line) (Example 1).

FIG. 3 shows stable dispersions of ZnO₂(1) NPs in selected organic solvents and in water (Example 1).

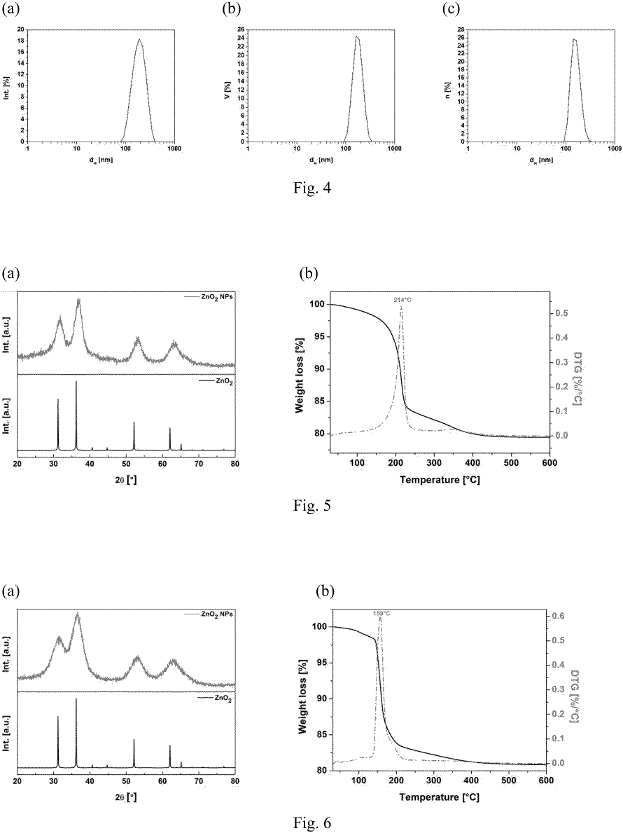

FIG. 4 shows solvodynamic diameter of the ZnO₂(1) NPs determined usig DLS method; (a) Int. -intensity, (b) V - volume, (c) n - number distributions (Example 1).

FIG. 5(a) shows powder X-ray diffraction pattern of ZnO₂(2) NPs together with a reference bulk ZnO₂ pattern, and FIG. 5(b) shows TG (solid line) and DTG (dashed line) traces recorded for ZnO₂(2) in a flow of synthetic air equal to 100 mL·min⁻¹ and at heating rate of 5 K·min⁻¹ (Example 2).

FIG. 6(a) shows powder X-ray diffraction pattern of ZnO₂(3) NPs together with a reference bulk ZnO₂ pattern, and FIG. 6(b) shows TG (solid line) and DTG (dashed line) traces recorded for ZnO₂(3) in a flow of synthetic air (Example 3).

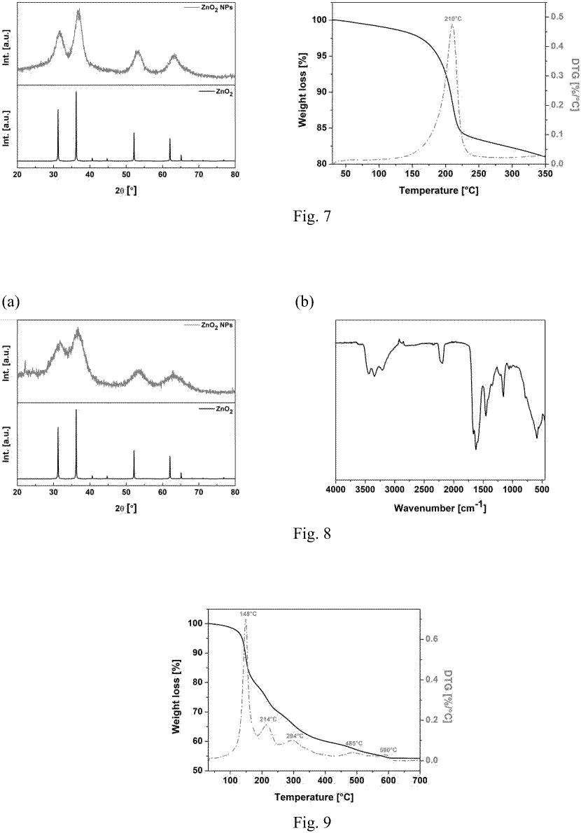

FIG. 7(a) shows powder X-ray diffraction pattern of ZnO₂(4) NPs together with a reference bulk ZnO₂ pattern, and FIG. 7(b) shows TG (solid line) and DTG (dashed line) traces recorded for ZnO₂(4) in a flow of synthetic air (Example 4).

FIG. 8(a) shows powder X-ray diffraction pattern, and FIG. 8(b) shows IR spectrum of ZnO₂(5) nanoparticles (Example 5).

FIG. 9 shows TG (solid line) and DTG (dashed line) traces recorded for ZnO₂(5) in a flow of synthetic air (Example 5).

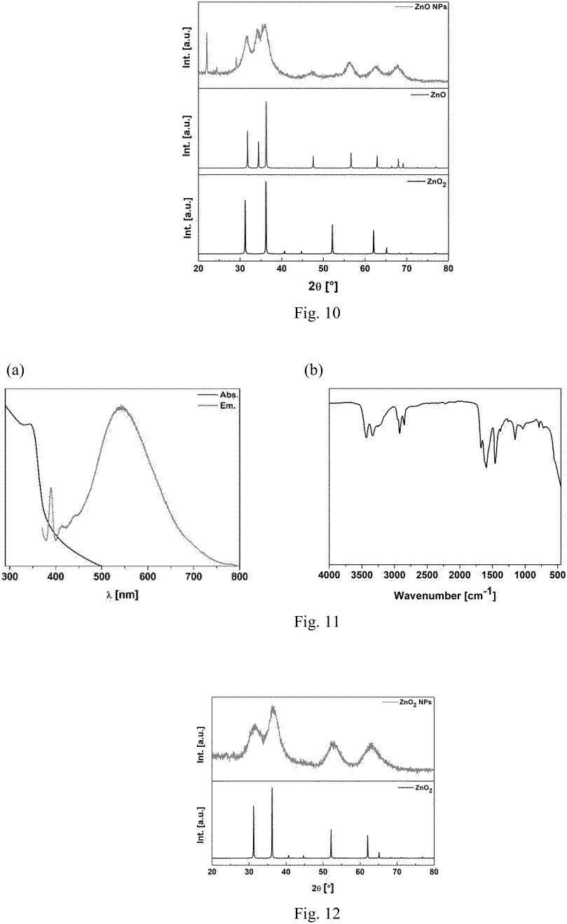

FIG. 10 shows powder X-ray diffraction pattern of ZnO NPs together with a reference bulk ZnO pattern (Example 5).

FIG. 11(a) shows absorption and emission, and FIG. 11(b) shows IR spectrum of ZnO nanoparticles (Example 5).

FIG. 12 shows powder X-ray diffraction pattern of ZnO₂(6) NPs together with a reference bulk ZnO₂ pattern (Example 6).

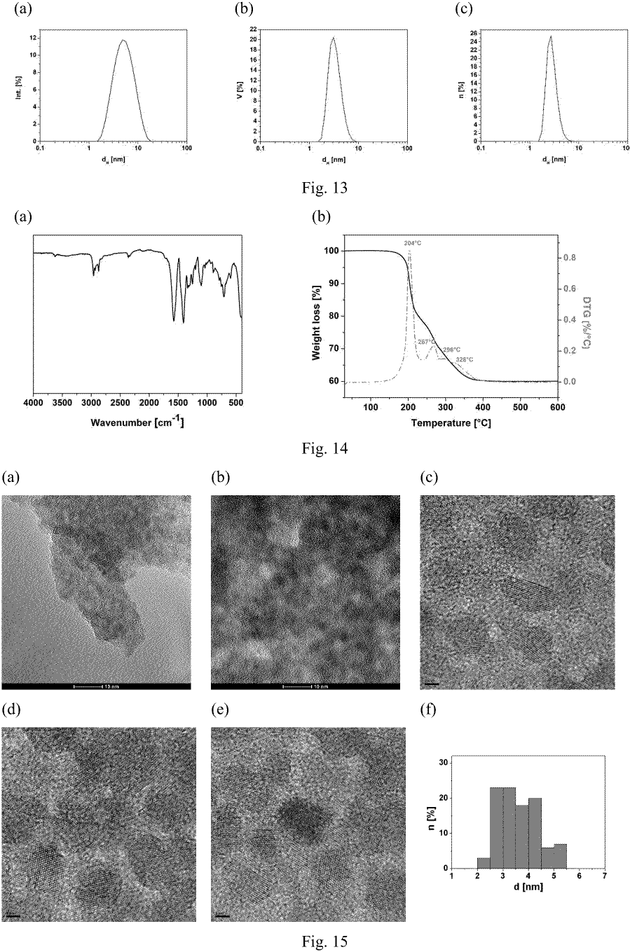

FIG. 13 shows solvodynamic diameter of the ZnO₂(6) NPs determined using DLS method; (a) Int. intensity, (b) Vvolume, (c) n - number distributions (Example 6).

FIG. 14(a) shows IR spectrum of ZnO₂(6) nanoparticles, and FIG. 14(b) shows TG (solid line) and DTG (dashed line) traces recorded for ZnO₂(6) in a flow of synthetic air (Example 6).

FIGS. 15(a - d) shows selected TEM micrographs of ZnO₂(7) NPs, and FIG. 15(f) shows size distribution of the resulting nanoparticles; symbols used in the drawing: n - counts, d - core diameter of the NPs (Example 7).

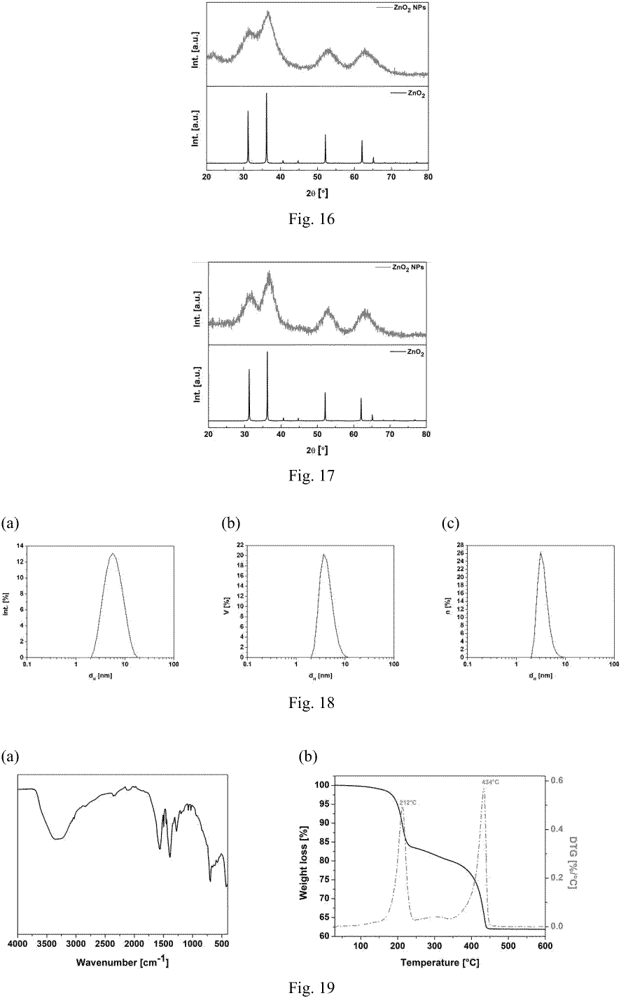

FIG. 16 shows powder X-ray diffraction pattern of ZnO₂(7) NPs together with a reference bulk ZnO₂ pattern (Example 7).

FIG. 17 shows powder X-ray diffraction pattern of ZnO₂(8) NPs together with a reference bulk ZnO₂ pattern (Example 8).

FIG. 18 shows solvodynamic diameter of the ZnO₂(8) NPs determined using DLS method; (a) Int. intensity, (b) Vvolume, (c) n - number distributions (Example 8).

FIG. 19(a) shows IR spectrum of ZnO₂(8) nanoparticles, and FIG. 19(b) shows TG (solid line) and DTG (dashed line) traces recorded for ZnO₂(8) in a flow of synthetic air (Example 8).

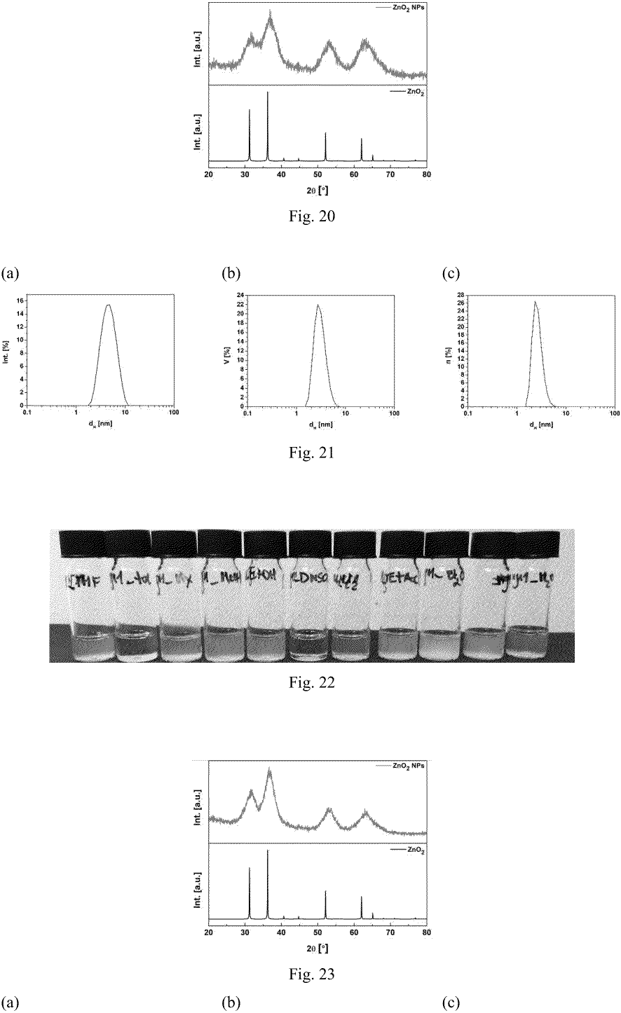

FIG. 20 shows powder X-ray diffraction pattern of ZnO₂(9) NPs together with a reference bulk ZnO₂ pattern (Example 9).

FIG. 21 shows solvodynamic diameter of the ZnO₂(9) NPs determined using DLS method; (a) Int. intensity, (b) Vvolume, (c) n - number distributions (Example 9).

FIG. 22 shows stable dispersions of ZnO₂(9) NPs in selected organic solvents and in water (Example 9).

FIG. 23 shows powder X-ray diffraction pattern of ZnO₂(10) NPs together with a reference bulk ZnO₂ pattern (Example 10).

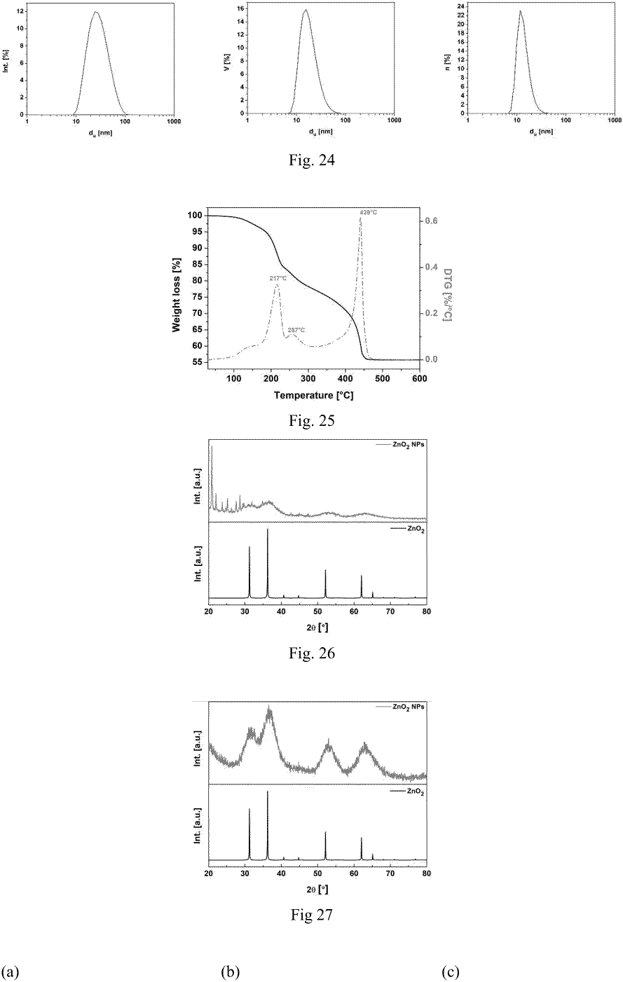

FIG. 24 shows solvodynamic diameter of the ZnO₂(10) NPs determined using DLS method; (a) Int. - intensity, (b) V - volume, (c) n - number distributions (Example 10).

FIG. 25 shows TG (solid line) and DTG (dashed line) traces recorded for ZnO₂(10) in a flow of synthetic air (Example 10).

FIG. 26 shows powder X-ray diffraction pattern of ZnO₂(11) NPs together with a reference bulk ZnO₂ pattern (Example 11).

FIG. 27 shows powder X-ray diffraction pattern of ZnO₂(12) NPs together with a reference bulk ZnO₂ pattern (Example 12).

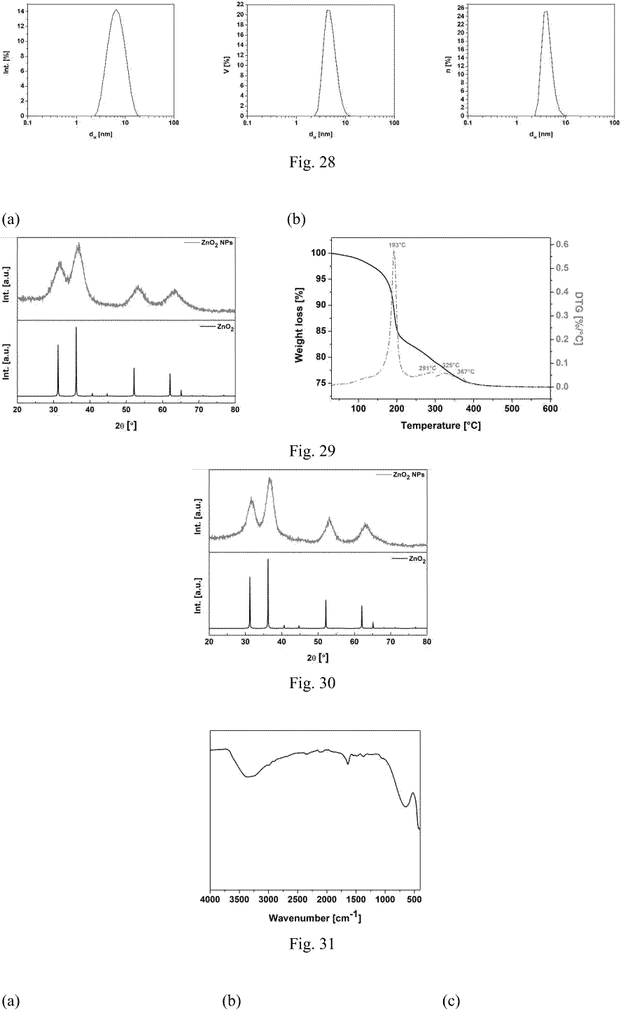

FIG. 28 shows solvodynamic diameter of the ZnO₂(12) NPs determined using DLS method; (a) Int. - intensity, (b) V - volume, (c) n - number distributions (Example 12).

FIG. 29(a) shows powder X-ray diffraction pattern of ZnO₂(13) NPs together with a reference bulk ZnO₂ pattern, and FIG. 29(b) shows TG (solid line) and DTG (dashed line) traces recorded for ZnO₂(13) in a flow of synthetic air (Example 13).

FIG. 30 shows powder X-ray diffraction pattern of ZnO₂(14) NPs together with a reference bulk ZnO₂ pattern (Exampel 14).

FIG. 31 shows IR spectrum of ZnO₂(14) nanoparticles (Example 14).

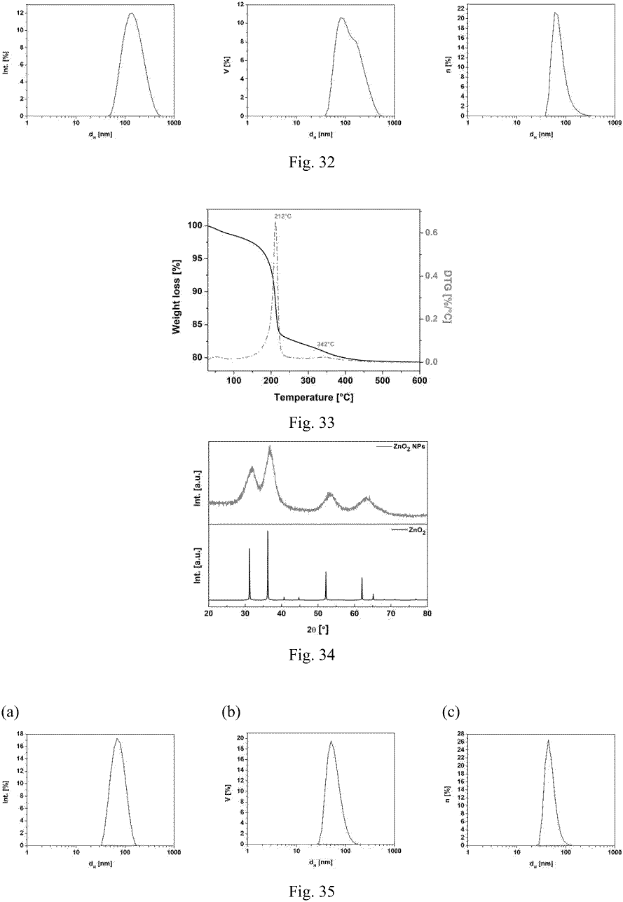

FIG. 32 shows solvodynamic diameter of the ZnO₂(14) NPs determined using DLS method; (a) Int. - intensity, (b) V - volume, (c) n - number distributions (Example 14).

FIG. 33 shows TG (solid line) and DTG (dashed line) traces recorded for ZnO₂(14) in a flow of synthetic air (Example 14).

FIG. 34 shows powder X-ray diffraction pattern of ZnO₂(15) NPs together with a reference bulk ZnO₂ pattern (Example 15).

FIG. 35 shows solvodynamic diameter of the ZnO₂(15) NPs determined using DLS method; (a) Int. - intensity, (b) V - volume, (c) n - number distributions (Example 15).

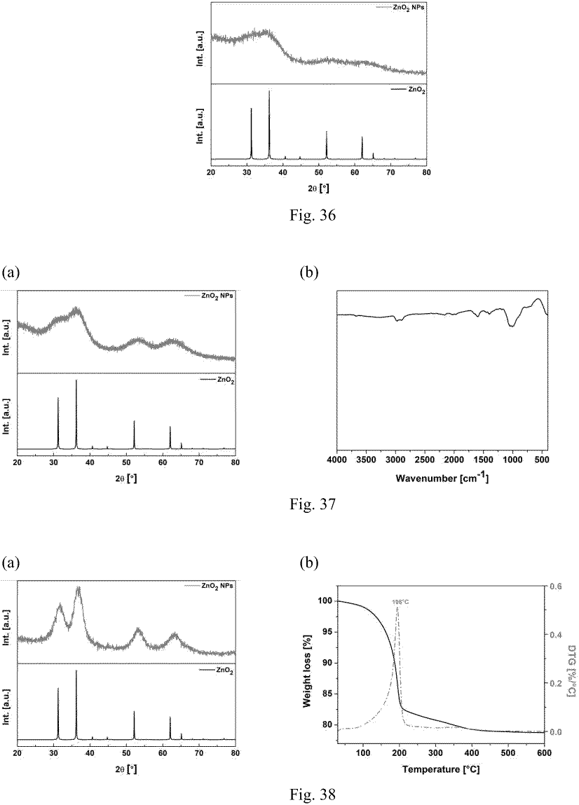

FIG. 36 shows powder X-ray diffraction pattern of ZnO₂(16) NPs together with a reference bulk ZnO₂ pattern (Example 16).

FIG. 37(a) shows powder X-ray diffraction pattern, and FIG. 37(b) shows IR spectrum of ZnO₂(17) nanoparticles (Example 17).

FIG. 38(a) shows powder X-ray diffraction pattern of ZnO₂(18) NPs, and FIG. 38(b) shows TG (solid line) and DTG (dashed line) traces recorded for ZnO₂(18) in a flow of synthetic air (Example 18).

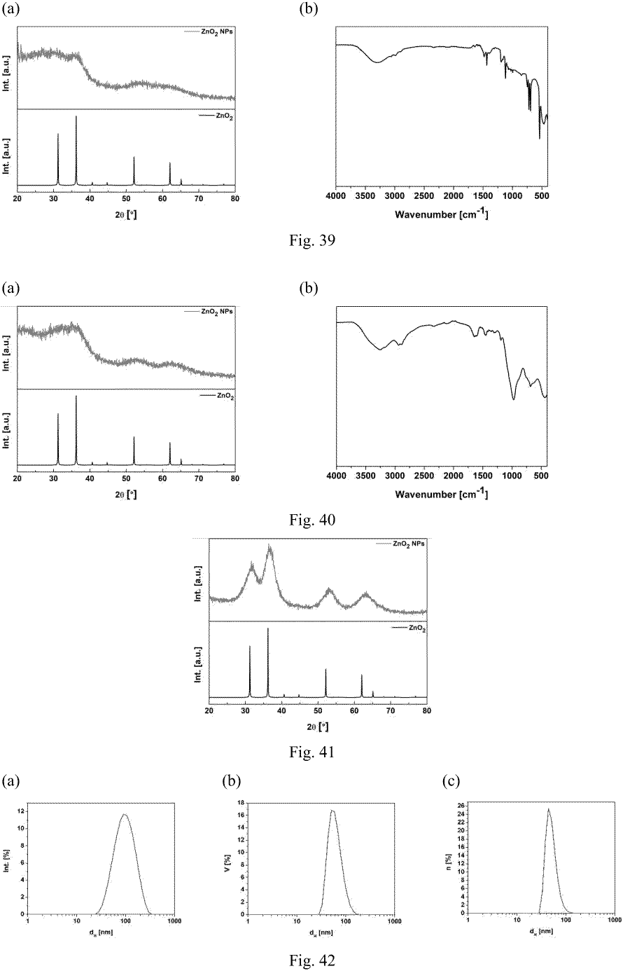

FIG. 39(a) shows powder X-ray diffraction pattern, and FIG. 39(b) shows IR spectrum of ZnO₂(19) nanoparticles (Example 19).

FIG. 40(a) shows powder X-ray diffraction pattern, and FIG. 40(b) shows IR spectrum of ZnO₂(20) nanoparticles (Example 20).

FIG. 41 shows powder X-ray diffraction pattern of ZnO₂(21) NPs together with a reference bulk ZnO₂ pattern (Example 21).

FIG. 42 shows solvodynamic diameter of the ZnO₂(21) NPs determined using DLS method; (a) Int. - intensity, (b) V - volume, (c) n - number distributions (Example 21).

FIG. 43 shows IR spectrum of ZnO₂(21) nanoparticles (Example 21).

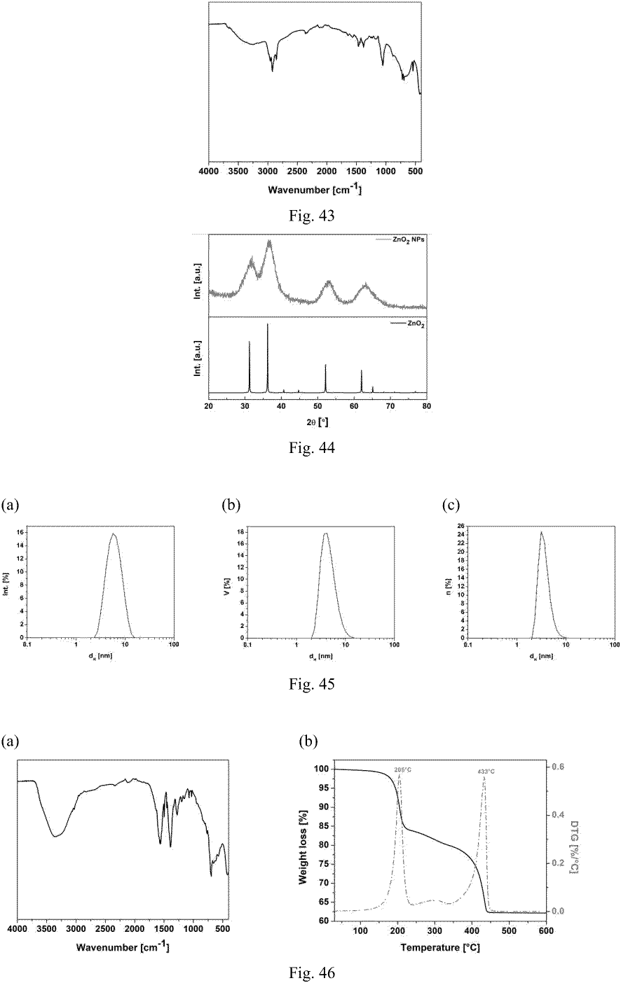

FIG. 44 shows powder X-ray diffraction pattern of ZnO₂(22) NPs together with a reference bulk ZnO₂ pattern (Example 22).

FIG. 45 shows solvodynamic diameter of the ZnO₂(22) NPs determined using DLS method; (a) Int. - intensity, (b) V - volume, (c) n - number distributions (Example 22).

FIG. 46(a) shows IR spectrum of ZnO₂(22) nanoparticles, and FIG. 46(b) shows TG (solid line) and DTG (dashed line) traces recorded for ZnO₂(22) in a flow of synthetic air (Example 22).

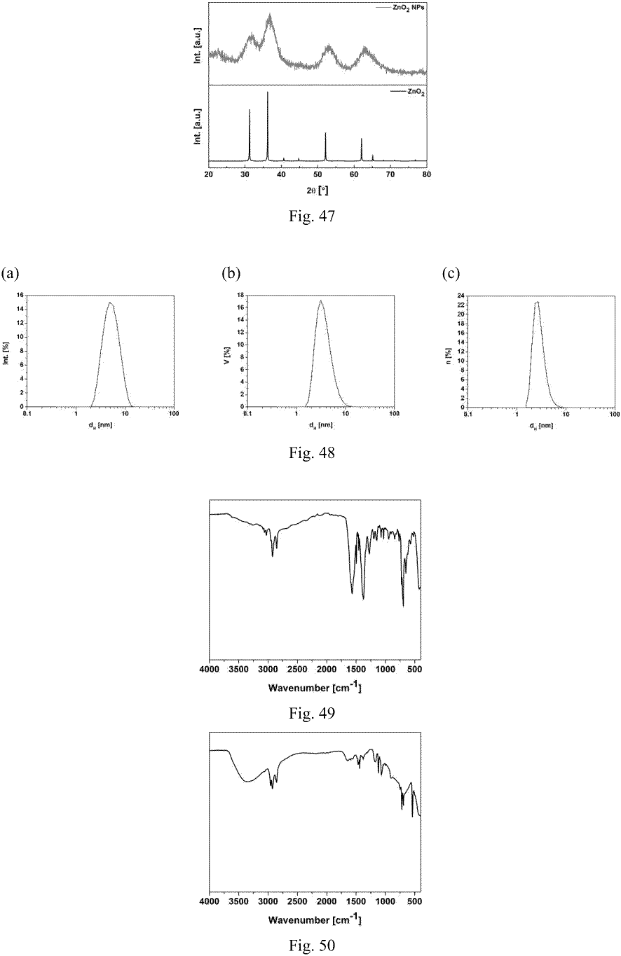

FIG. 47 shows powder X-ray diffraction pattern of ZnO₂(23) NPs together with a reference bulk ZnO₂ pattern (Example 25).

FIG. 48 shows solvodynamic diameter of the ZnO₂(23) NPs determined using DLS method; (a) Int. - intensity, (b) V - volume, (c) n - number distributions (Example 25).

FIG. 49 shows IR spectrum of ZnO₂(23) nanoparticles (Example 25).

FIG. 50 shows IR spectrum of ZnO₂(24) nanoparticles (Example 26).

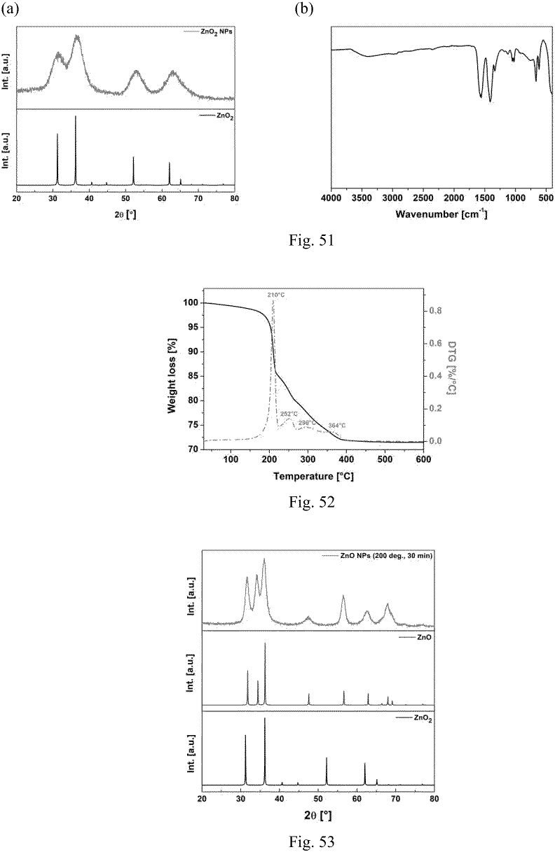

FIG. 51(a) shows powder X-ray diffraction pattern, a FIG. 51(b) shows IR spectrum of ZnO₂(25) nanoparticles (Example 27).

FIG. 52 shows TG (solid line) and DTG (dashed line) traces recorded for ZnO₂(25) in a flow of synthetic air (Example 27).

FIG. 53 shows powder X-ray diffraction pattern of nanocrystalline ZnO prepered by annealing of ZnO₂(3) NPs together with a reference bulk ZnO pattern (Example 28).

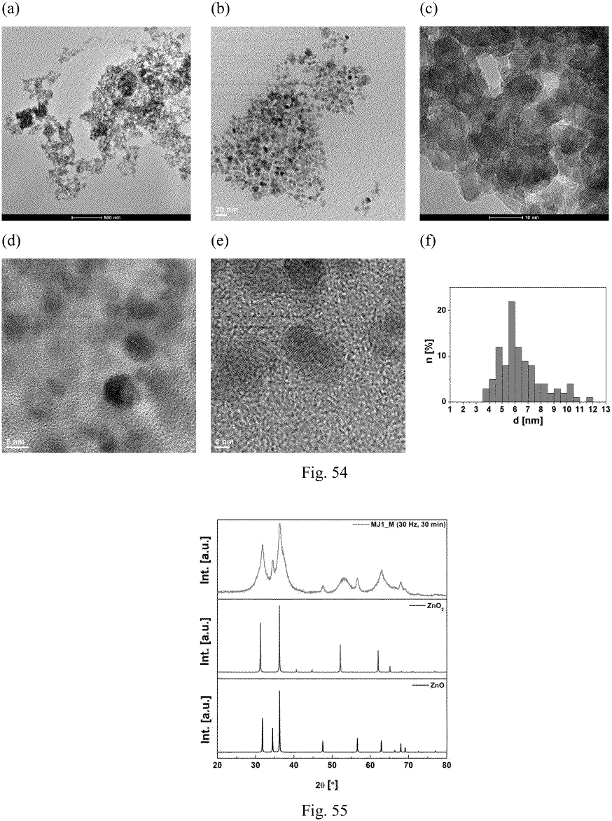

FIGS. 54 (a - d) shows selected TEM micrographs of ZnO NPs obtained as a result of the ZnO₂(3) NPs annealing process and FIG. 54(f) shows size distribution of the resulting ZnO nanoparticles; symbols used in the drawing: n - counts, d - core diameter of the NPs (Example 1).

FIG. 55 shows powder X-ray diffraction pattern of the product prepered by grinding of ZnO₂(3) NPs together with a reference bulk ZnO and ZnO₂ patterns (Example 29).

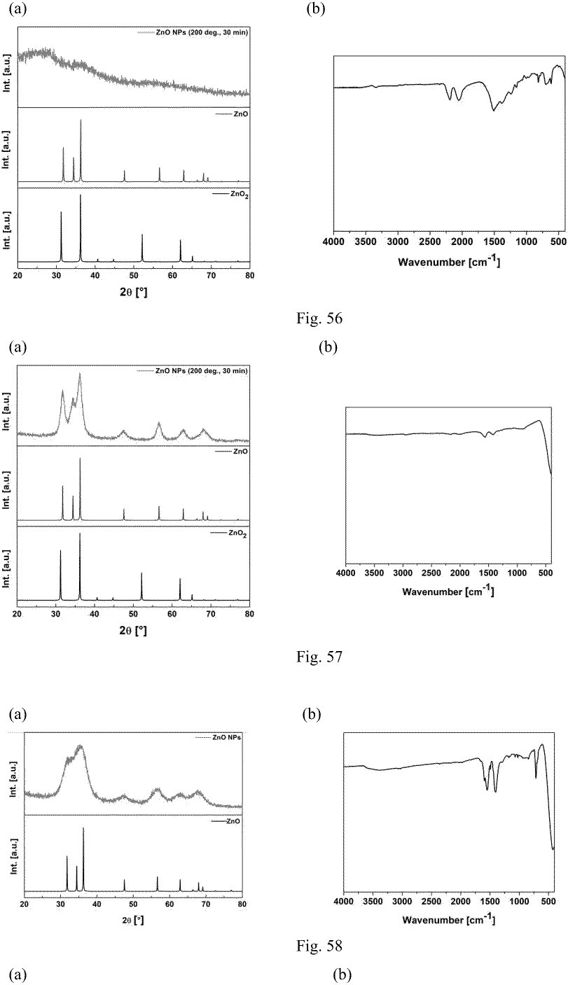

FIG. 56(a) shows powder X-ray diffraction pattern, and FIG. 56(b) shows IR spectrum of nanocrystalline ZnO prepered by annealing of ZnO₂(5) NPs (Example 30).

FIG. 57(a) shows powder X-ray diffraction pattern, and FIG. 57(b) shows IR spectrum of nanocrystalline ZnO prepered by annealing of ZnO₂(6) NPs (Example 31).

FIG. 58(a) shows powder X-ray diffraction pattern, and FIG. 58(b) shows IR spectrum of nanocrystalline ZnO prepered by annealing of ZnO₂(8) NPs (Example 32).

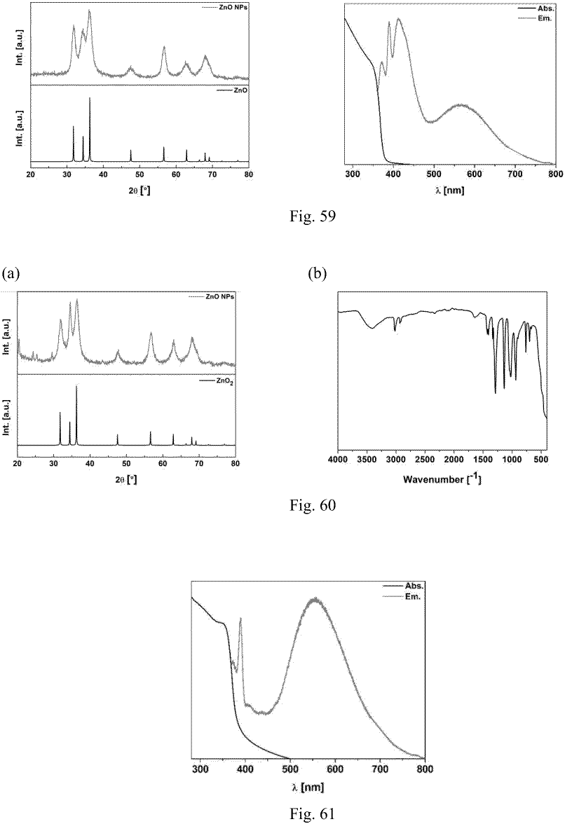

FIG. 59(a) shows powder X-ray diffraction pattern, and FIG. 59(b) shows absorption and emission spectra of ZnO prepered by annealing of ZnO₂(25) NPs together with a reference bulk ZnO pattern (Example 33).

FIG. 60(a) shows powder X-ray diffraction pattern, and FIG. 60(b) shows IR spectrum of nanocrystalline ZnO obtained in Example 34.

FIG. 61 shows absorption and emission spectra of ZnO NPs obtained in Example 34.

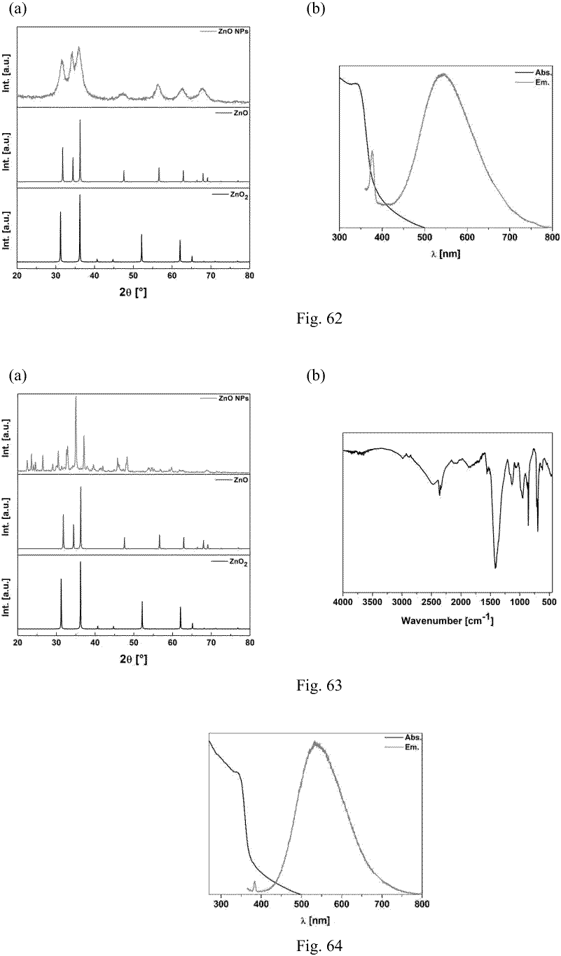

FIG. 62(a) shows powder X-ray diffraction pattern, a FIG. 62(b) shows absorption and emission spectra of nanocrystalline ZnO obtained in Example 35.

FIG. 63(a) shows powder X-ray diffraction pattern, and FIG. 63(b) shows IR spectrum of nanocrystalline ZnO obtained in Example 36.

FIG. 64 shows absorption and emission spectra of ZnO NPs obtained in Example 36.

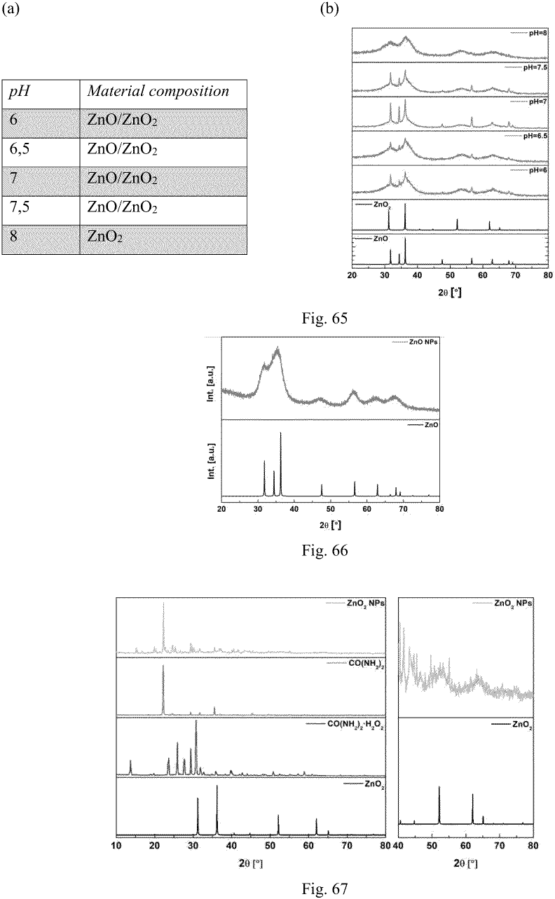

FIG. 65 presents results of the stability study of ZnO₂(3) NPs in solutions of different pH; (a) composition and (b) powder X-ray diffraction patterns of materials obtained as a result of storage of nanocrystalline zinc peroxide in solutions with different pH (Example 37).

FIG. 66 shows powder X-ray diffraction pattern of nanocrystalline ZnO obtained in Example 38 together with a reference bulk ZnO pattern.

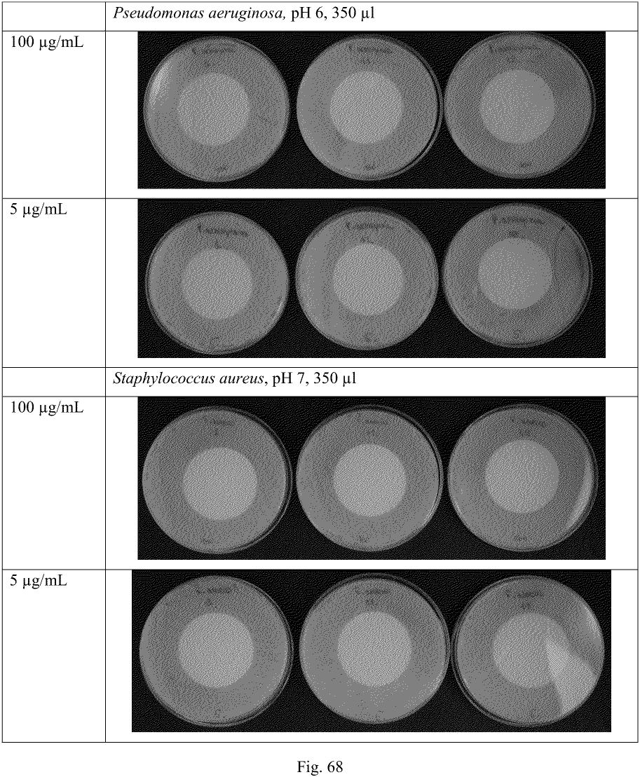

FIG. 67 shows powder X-ray diffraction pattern of nanocrystalline ZnO₂ prepared by mechanosynthesis (Example 39).

FIG. 68 shows photos indicating the antibacterial properties of ZnO₂ NPs (Example 40).

The following examples present the subjects of the invention.

In all examples, anhydrous solvents pre-dried over molecular sieves, heated with a potassium-sodium alloy and distilled in an atmosphere of dry and oxygen-free inert gas or purified in a solvent purification system (SPS) were used, and depending on the cleaning conditions, they may contain insignificant amounts of water, i.e., less than 0.5%. In all examples, except for Example 4, commercially available dialkyl- or diarylzinc compounds were used with the purity declared by the manufacturer as technical grade (90-99%). The applied in the examples term ambient temperature means a temperature in the range from 10° C. to 30° C., and room temperature means a temperature in the range from 22° C. to 27° C. The resulting materials were characterized by a wide range of analytical techniques, such as transmission electron microscopy (TEM), powder X-ray diffraction (PXRD), infrared spectroscopy (FTIR), thermogravimetric analysis (TGA) and dynamic light scattering (DLS).

The abbreviations ZnO₂ NPs and ZnO NPs used throughout the description refer to nanoparticles of zinc peroxide and nanoparticles of zinc oxide, respectively.

### EXAMPLE 1

### Preparation of ZnO₂ NPs in a Reaction Between Et₂Zn and Perhydrol in an Aprotic Organic Solvent

10 mL of anhydrous solvent - tetrahydrofuran (THF) was introduced into a Schlenk vessel (V = 100 cm³) equipped with a magnetic stir bar and cooled to -78° C. Et₂Zn (0.5 mL of a 2 M solution in hexane, 1 mmol) and 0.1 mL of perhydrol (30% aqueous solution of H₂O₂, 1 mmol H₂O₂) were then added dropwise via a syringe and under an inert gas atmosphere. Initially the reaction was carried out at -78° C. for ca. 10 minutes. Then the reaction mixture was allowed to gradually warm to room temperature and left at this temperature for additional 30 minutes. After this time, the product in the form of a white precipitate, which is nanocrystalline ZnO₂ (from now on termed ZnO₂(1) NPs), was obtained and characterized. TEM micrographs of the resulting ZnO₂ nanoparticles as well as size distribution of ZnO₂(1) NPs are shown in FIG. 1. The micrographs show quasi-spherical ZnO₂ nanocrystallites with a core size of a few nanometers (ca. 2 - 7 nm) and a mean core diameter equal to 3.81 ± 0.65 nm (FIG. 1). Results obtained by the powder X-ray diffraction method (both the presence and the broadening of reflections 31.0 (1 1 1), 36.5 (2 0 0), 53.0 (2 2 0) and 63.0 (3 1 1) 2Θ characteristic for the cubic crystal phase of zinc peroxide) confirmed the presence of nanocrystalline ZnO₂ in the tested material. Absence of the additional reflections in the X-ray diffraction pattern shown in Error! Reference source not found. indicated the high phase purity of the resulting product. Moreover, careful PXRD analysis revealed that NPs are pretty regular in shape and the average size of nanocrystallites determined by Scherrer’s formula is ca. 3.00 ± 0.14 nm as well as it does not change in time (Error! Reference source not found.). ZnO₂ nanoparticles prepared according to the above method form stable suspensions in common organic solvents (such as toluene, methanol, ethanol, DMSO, ethyl acetate, acetone) and water (Error! Reference source not found.). DLS analysis exhibits that the average size of ZnO₂(1) NPs associates present in DMSO is ca. 170 nm, and the relatively low polydispersity index (PdI = 0.174) indicates a high similarity, almost uniformity in shape, and narrow size distribution of the resulting nanostructures (Error! Reference source not found.).

### EXAMPLE 2

### Preparation of ZnO₂ NPs in a Reaction Between iPr₂Zn and Perhydrol in an Aprotic Organic Solvent

iPr₂Zn (1 mL of a 1 M solution in toluene, 1 mmol) and 0.1 mL of perhydrol (1 mmol of H₂O₂) were successively added dropwise to 10 mL of solvent mixture (5 mL of THF + 5 mL of hexane) placed in a Schlenk vessel, vigorously stirred with a magnetic stir bar and cooled to -10° C. The reaction was carried out at -10° C. for ca. 5 minutes. Then the reaction mixture was allowed to reach room temperature and stirred at this temperature for additional 24 hours. As a result, nanocrystalline ZnO₂ (from now on termed ZnO₂(2) NPs) was obtained and the crystal structure of the resulting product was then confirmed using PXRD (Error! Reference source not found. a; the average size of nanocrystallites is 3.36 ± 0.37 nm). Nanocrystalline ZnO₂(2) decomposes into ZnO at 214° C. (Error! Reference source not found. b). Similar results have been obtained using other dilalkylzinc compounds such as dimethylzinc, di-tert-butylzinc, dicyclopentylzinc, dicyclohexylzinc or dicyclopentadienylzinc.

### EXAMPLE 3

### Preparation of ZnO₂ NPs in a Reaction Between Et₂Zn and Perhydrol in an Aprotic Organic Solvent

Et₂Zn (1 mL of a 1 M solution in hexane, 1 mmol) and 0.1 mL of perhydrol (1 mmol of H₂O₂) were successively added dropwise to 10 mL of hexane placed in a Schlenk vessel, vigorously stirred with a magnetic stir bar and cooled to -78° C. The reaction mixture was left at -78° C. for a few minutes and then warmed to room temperature and stirred for additional 30 minutes. ZnO₂(3) nanoparticles were obtained as a white solid, which was then decanted and dried under vacuum. PXRD analysis confirmed the nanocrystalline cubic crystal structure of ZnO₂(3) (Error! Reference source not found. a; the average size of nanocrystallites is 2.26 ± 0.24 nm). Thermolysis of ZnO₂(3) NPs occurs with a maximum decomposition rate at 158° C. and the decomposition process is finished at ca. 400° C. (FIG. 6b ). The determined total weight loss well corresponds to both the removal of water molecules adsorbed on the NPs surface as well as the quantitative transformation of ZnO₂ to ZnO.

### EXAMPLE 4

### Preparation of ZnO₂ NPs in a Reaction Between High Purity Et₂Zn (99.9998%) and Perhydrol

The reaction between high purity Et₂Zn (99.9998%) and perhydrol was carried out according to the procedure described in Example 3 leads to the formation of nanocrystalline ZnO₂ (from now on termed ZnO₂(4) NPs) with physicochemical properties similar to ZnO₂(1) and ZnO₂(3)NPs. The average size of nanocrystallites calculated from Scherrer’s formula is 3.2 ± 0.21 nm. The lack of additional diffraction peaks proves the high purity of the tested material (Error! Reference source not found. a). FTIR analysis revealed the presence of IR bands characteristic of Zn—O (403 cm⁻¹) and O—O (1487 and 1376 cm⁻¹) species that are present in the structure of ZnO₂(4). The thermal stability of the product was determined by thermogravimetric analysis. Decomposition of nanocrystalline ZnO₂(4) occurs with a maximum decomposition rate at 210° C., which indicates the quantitative transformation of ZnO₂ to ZnO (Error! Reference source not found. b).

### EXAMPLE 5

### Preparation of ZnO₂ NPs in a Reaction Between Et₂Zn and CO(NH₂)₂·H₂O₂ in a Molar Ratio of 1:3

282 mg (3 mmol) of hydrogen peroxide-urea adduct (CO(NH₂)₂·H₂O₂) in 10 mL of THF was placed in a Schlenk vessel equipped with a magnetic stir bar. The resulting solution was cooled in a dry ice - isopropyl alcohol bath to -78° C. Et₂Zn (0.5 mL of a 2 M solution in hexane, 1 mmol) was then added dropwise via a syringe and under an inert gas atmosphere. The reaction was carried out at -78° C. for ca. 20 minutes. Then the reaction mixture was allowed to spontaneously warm to ambient temperature and stirred at this temperature for additional 24 hours. Hereby, the product was obtained as a yellow precipitate, which was then decanted, purified by washing the resulting product two times with a small portions of ethanol and centrifugated (9000 rpm, 10 minutes). Nanocrystalline zinc peroxide (ZnO₂(5) NPs) with a mean core size of 1.71 ± 0.21 nm was identified by PXRD (Error! Reference source not found. a). The lack of additional peaks on the diffraction pattern proves the high purity of the tested sample. Slight changes in the intensity and the bands’ position corresponding to C═O and N—H moieties, respectively, demonstrate the possible coordination of both the carbonyl and the amine groups on the surface of the resulting ZnO₂ NPs (Error! Reference source not found. b). Thermogravimetric analysis of ZnO₂(5) NPs indicates more complex nature of the decomposition profile of the tested system compared to those presented in the previous examples. Thermal decomposition of urea (which is a compound with a low melting point, i.e., ~133° C., and quickly decomposes at higher temperatures) occurs at 149° C., while the transformation of ZnO₂ to ZnO begins at higher temperatures with a maximum decomposition rate at 214° C. (FIG. 9). A product with similar properties can be obtained using diethyl ether as a solvent in the synthesic process or using various THF/diethyl ether mixtures. Changing the molar ratio of Et₂Zn—CO(NH₂)₂·H₂O₂ from 1:3 to 1:1 leads to the suspension, which exhibits yellow luminescence under UV light irradiation immediately after air exposure and under UV light irradiation. The presence of nanocrystalline ZnO with the crystal structure of wurtzite and the average size of nanocrystallites equal to 4.61 ± 0.77 nm was confirmed using PXRD (Error! Reference source not found.). Absorption and emission spectra of ZnO NPs dispersed in DMSO are shown in Error! Reference source not found. a. NPs revealed a broad and well-formed absorption band with a maximum at λ_{abs} = 345 nm and intense emission in the visible light range (λₑₘ = 543 nm). Slight changes in the intensity and the position of the bands corresponding to both the C═O and N—H vibrations indicate coordination on these groups on the surface of ZnO NPs (Error! Reference source not found. b).

### EXAMPLE 6

### Preparation of ZnO₂ NPs Coated With an Organic Shell Composed of Monoanionic Derivatives of Butyric Acid - One-Step Approach

88 mg (1 mmol) of butyric acid (C₃H₇COOH) or 214 mg (1 mmol) of heptafluorobutyric acid (C₃F₇COOH) in 10 mL of THF was placed in a Schlenk vessel equipped with a magnetic stir bar. The resulting solution was cooled in a dry ice - isopropyl alcohol bath to -78° C. Et₂Zn (0.5 mL of a 2 M solution in hexane, 1 mmol) and 0.1 mL of perhydrol (1 mmol of H₂O₂) were then sequentially added dropwise using a syringe and under an inert gas atmosphere. After a while, the cooling bath was removed and the reaction mixture was allowed to spontaneously warm to ambient temperature and stirred at this temperature for additional 24 hours. A clear stable colloidal solution of ZnO₂ nanoparticles (ZnO₂(6) NPs) was obtained. The reaction product was precipitated from the post-reaction system using hexane (ca. 5 mL) and isolated by centrifugation (9000 rpm, 10 minutes). The resulting sediment was then washed with a small portion of hexane (2 mL), re-centrifuged and dried under vacuum. PXRD analysis (Error! Reference source not found.) confirmed the nanocrystalline cubic crystal structure of ZnO₂(6) NPs and the average core size was determined to be 2.29 ± 0.31 nm. The lack of additional peaks on the diffraction pattern proves the high purity of the tested sample. Similar results have been obtained using glycine and 2-hydroxypropanoic acid. DLS analysis showed that the average solvodynamic diameter of the ZnO₂(6) nanoparticles is 4.63 nm. Moreover, a low degree of polydispersity index (PdI = 0.157) indicated a narrow size distribution and high colloidal stability of ZnO₂(6) NPs (Error! Reference source not found.). FTIR analysis confirmed the presence of an organic shell composed of deprotonated butyric acid molecules on the surface of nanocrystalline ZnO₂ (Error! Reference source not found. a). Absence of a band characteristic for C═O stretching vibrations in the butyric acid molecule (1712 cm⁻¹) and the appearance of the asymmetric vₐₛ(COO⁻) and the symmetric vₛ(COO⁻) stretches at 1569 and 1406 cm⁻¹ (Δv = 163 cm⁻¹), respectively, indicates that monoanionic carboxylate moieties bound to the ZnO₂(6) NPs surface and act as bridging bidentate µ₂-type ligands. The decomposition temperature of ZnO₂ into ZnO is 204° C. We also noted that at higher temperatures (i.e., above 250° C.) the organic shell of ZnO₂(6) NPs decomposes (Error! Reference source not found. b).

### EXAMPLE 7

### Preparation of ZnO₂ NPs Coated With an Organic Shell Composed of Monoanionic Derivatives of Butyric Acid - Two-Step Approach

In the first step, 88 mg (1 mmol) of butyric acid in 10 mL of THF was placed in a Schlenk vessel equipped with a magnetic stir bar. The resulting solution was cooled in a dry ice - isopropyl alcohol bath to -78° C. and Et₂Zn (0.34 mL of a 3 M solution in hexane, 1 mmol) was then added dropwise using a syringe and under an inert gas atmosphere. Initially the reaction was carried out at a reduced temperature and then it was allowed to gradually warm to room temperature and stirred at this temperature for additional 3 hours. After this time, the molecular structure of the resulting product in the form of an ethylzinc derivative of butyric acid was confirmed by spectroscopic methods. In the next step, 0.1 mL of 30% aqueous solution of H₂O₂ (1 mmol) was added dropwise to the as-prepared organozinc precursor solution cooled to the temperature of a dry ice - isopropyl alcohol cooling bath. The reaction mixture was allowed to gradually warm to room temperature and stirred at this temperature for additional 12 hours. Then a clear stable solution was obtained. Product in the form of nanocrystalline ZnO₂ (from now on termed ZnO₂(7) NPs) was isolated from the post-reaction mixture and purified according to the method described in Example 6. TEM micrographs of the resulting ZnO₂ nanoparticles as well as the size distribution of ZnO₂(7) NPs are shown in Error! Reference source not found.. The micrographs show quasi-spherical ZnO₂ nanocrystallites with a core size of a few nanometers (ca. 2 - 5.5 nm) and a mean core diameter of 3.66 ± 0.79 nm (Error! Reference source not found. f). The average core size of ZnO₂(7) determined by PXRD (Error! Reference source not found.) is 2.11 ± 0.19 nm. Similar results have been obtained using glycine and 2-hydroxypropanoic acid.

### EXAMPLE 8

### Preparation of ZnO₂ NPs Coated With an Organic Shell Composed of Phenylacetate Ligands

136 mg (1 mmol) of phenylacetic acid (C₇H₇COOH) in 10 mL of THF was placed in a Schlenk vessel equipped with a magnetic stir bar. The resulting solution was cooled in a dry ice -isopropyl alcohol bath to -78° C. Et₂Zn (0.5 mL of a 2 M solution in hexane, 1 mmol) and 0.1 mL of perhydrol (1 mmol of H₂O₂) were then sequentially added dropwise using a syringe and under an inert gas atmosphere. The reaction was carried out at -78° C. for ca. 10 minutes. Then the reaction mixture was allowed to spontaneously warm to ambient temperature and stirred at this temperature for additional 24 hours. A clear, stable solution was obtained. The reaction product was isolated and purified according to the method described in Example 6 as well as identified as nanocrystalline zinc peroxide (from now on termed (ZnO₂(8) NPs) (Error! Reference source not found.). The average core size of ZnO₂ is 2.24 ± 0.23 nm. DLS analysis in THF confirmed the monodispersity of the tested system (PdI = 0.168) and the solvodynamic diameter equal to 5.55 nm (Error! Reference source not found.). FTIR analysis revealed the presence of an organic shell composed of deprotonated phenylacetic acid molecules attached to the surface of the nanocrystalline ZnO₂ core (Error! Reference source not found. a). The thermal decomposition of this material shown in FIG. 19b indicates the transformation of ZnO₂ to ZnO at 212° C. (weight loss of 16.6%) and the decomposition of organic ligand shell at 434° C. (weight loss of 21.2%).

### EXAMPLE 9

### Preparation of ZnO₂ NPs Coated With an Organic Shell Composed of Monoanionic Derivatives of 2-(2-methoxyethoxy)acetic Acid or Monoanionic Derivatives of Betaine

134 mg (1 mmol) 2-methoxyethoxy)acetic acid (CH₃OCH₂CH₂OCH₂COOH) or 117 mg (1 mmol) of betaine (i.e., zwitterion compound with an positively charged cationic functional quaternary ammonium group - (CH₃)₃N⁺CH₂CO₂₋) in 10 mL of THF was placed in a Schlenk vessel equipped with a magnetic stir bar. The resulting solution was cooled to 0° C. and Et₂Zn (0.5 mL of a 2 M solution in hexane, 1 mmol) and 0.1 mL of perhydrol (1 mmol of H₂O₂) were then sequentially added dropwise using a syringe and under an inert gas atmosphere. The reaction was carried out at 0° C. for ca. 1 hour. Then the reaction mixture was allowed to reach ambient temperature and stirred at this temperature for additional 24 hours. After this time, a stable slightly turbid colloid was obtained and nanocrystalline ZnO₂ (from now on termed ZnO₂(9) NPs) was precipitated after the addition of 5 mL of ethanol and isolated from the resulting mixture by centrifugation (9000 rpm, 10 minutes). The resulting sediment was washed with a small portion of ethanol (2 mL), re-centrifuged and dried under vacuum. PXRD analysis confirmed the nanocrystalline, cubic crystal structure of the resulting ZnO₂ and the average core size of crystallites is 1.96 ± 0.17 nm (Error! Reference source not found.). Solvodynamic diameter of ZnO₂(9) NPs is 4.83 nm (PdI = 0.082) (Error! Reference source not found.). The presence of a stable and strongly bound protective layer on the surface of ZnO₂ composed of carboxylate ligands was confirmed by FTIR method. ZnO₂(9) NPs form stable colloidal solutions or stable suspensions in organic solvents such as THF, toluene, hexane, methanol, ethanol, DMSO, dichloromethane, ethyl acetate, diethyl ether and acetone as well as in water (Error! Reference source not found.). Likewise, betaine-coated ZnO₂ NPs form stable dispersions in a wide range of organic solvents and water.

### EXAMPLE 10

### Preparation of ZnO₂ NPs Coated With an Organic Shell Composed of Monoanionic Derivatives of S-(+)-2-amino-1-phenylethanol

In the first step, 137 mg (1 mmol) of S-(+)-2-amino-1-phenylethanol (C₆H₅CH(OH)CH₂(NH₂) in 10 mL of THF was placed in a Schlenk vessel equipped with a magnetic stir bar. Then the resulting solution was cooled in a dry ice - isopropyl alcohol bath to -78° C. and Et₂Zn (0.5 mL of a 2 M solution in hexane, 1 mmol) and 0.1 mL of perhydrol (1 mmol of H₂O₂) were then added dropwise using a syringe and under an inert gas atmosphere. Initially the reaction was carried out at -78° C. for ca. 10 minutes and then it was allowed to gradually warm to room temperature and stirred at this temperature for additional 24 hours. After this time, the molecular structure of the resulting product in the form of an ethyl zinc derivative of S-(+)-2-amino-1-phenylethanol was confirmed by spectroscopic methods. In the next step, 0.1 mL of 30% aqueous solution of H₂O₂ (1 mmol) was added dropwise to the as-prepared organozinc precursor solution cooled to the temperature of a dry ice - isopropyl alcohol cooling bath. Then the reaction mixture was allowed to gradually warm to room temperature and stirred at ambient temperature for additional 24 hours (note that the reaction time can be shortened by heating the reaction mixture at reflux temperature, i.e., 65° C. - 70° C. for 3 - 4 hours). After that, a stable slightly turbid colloid was obtained. The product in the form of nanocrystalline ZnO₂ (from now on termed ZnO₂(10) NPs) was isolated from the post-reaction mixture and purified according to the method described in Example 6. The average core size of ZnO₂(10) determined by PXRD (Error! Reference source not found.) is 2.55 ± 0.33 nm and the solvodynamic diameter of the associates present in the solution is 25.54 nm (PdI = 0.169) (Error! Reference source not found.). TGA profile shown in Error! Reference source not found. exhibits two main decomposition steps with maximum decomposition rates at 214° C. and 439° C., respectively, and the thermolysis is finished at ~ 450° C. with a total weight loss of 44.24%.

### EXAMPLE 11

### Preparation of ZnO₂ NPs Coated With Diphenyl Phosphate Ligands

250 mg (1 mmol) of diphenyl phosphate ((C₆H₅O)₂P(O)OH) in 10 mL of THF was placed in a Schlenk vessel equipped with a magnetic stir bar. The resulting solution was cooled to -78° C. Et₂Zn (0.5 mL of a 2 M solution in hexane, 1 mmol) and 0.1 mL of perhydrol (1 mmol of H₂O₂) were then sequentially added dropwise using a syringe and under an inert gas atmosphere. Similar results can be obtained using a crystalline organozinc precursor of the formula [tBuZn(O₂P(OPh)₂]₄. Initially the reaction was carried out at -78° C. for ca. 10 minutes and then it was allowed to gradually warm to ambient temperature and stirred at this temperature for additional 4 hours. After this time, a colorless solution was obtained. The reaction product was then isolated and purified according to the method described in Example 6 and identified as nanocrystalline zinc peroxide (from now on termed ZnOz(11) NPs) with a small core size equal to 1.60 ± 0.10 nm (Error! Reference source not found.). Similar results have been obtained using other organophosphorous compounds such as phenyl dihydrogen phosphate, diphenylphosphinic acid or phenylphosphonic acid.

### EXAMPLE 12

### Preparation of ZnO₂ NPs Coated With an Organic Shell Composed of Monoanionic Derivatives of Myristic Acid

In the first step, 228 mg (1 mmol) of myristic acid (CH₃(CH₂)₁₂COOH) in 10 mL of THF was placed in a Schlenk vessel equipped with a magnetic stir bar. The resulting solution was cooled in a dry ice - isopropyl alcohol bath to -78° C. and Et₂Zn (0.5 mL of a 2 M solution in hexane, 1 mmol) was then added dropwise using a syringe and under an inert gas atmosphere. Initially the reaction was carried out at the temperature of the cooling bath and then it was allowed to gradually warm to room temperature and stirred at this temperature for additional 5 hours. After this time, the molecular structure of the resulting product in the form of an ethyl zinc derivative of myristic acid was confirmed by spectroscopic methods. In the next step, 0.2 mL of 15% aqueous solution of H₂O₂ (1 mmol) was added dropwise to the as-prepared organozinc precursor cooled to the temperature of a dry ice - isopropyl alcohol cooling bath. Then the reaction mixture was allowed to gradually warm to room temperature and stirred at ambient temperature for one day. After this time, a clear solution was obtained. Product in the form of nanocrystalline ZnO₂ (from now on termed ZnO₂(12) NPs) was isolated from the post-reaction mixture and purified according to the method described in Example 6. PXRD analysis (Error! Reference source not found.) confirmed the nanocrystalline structure of the resulting nanoparticles and the average core size was determined to be 2.01 ± 0.13 nm. The solvodynamic diameter of ZnO₂(12) NPs in THF is 5.98 nm and the resulting solution is characterized by high colloidal stability and monodispersity (PdI = 0.122) (Error! Reference source not found.). Absence of a band characteristic for C=O stretching vibrations in the myristic acid molecule (~ 1700 cm⁻¹) and the appearance of the asymmetric vₐₛ(COO⁻) and the symmetric vₛ(COO⁻) stretches at 1581 and 1416 cm⁻¹ (Δv = 165 cm⁻ ¹), respectively, indicates the presence of monoanionic carboxylate ligand bound to the surface of ZnO₂(12) NPs.

### EXAMPLE 13

### Preparation of ZnO₂ NPs Using Ethylzinc Derivative of Propionamide as a Precursor

In the first step, 73 mg (1 mmol) of propionamide (CH₃CH₂CONH₂) in 10 mL of THF was placed in a Schlenk vessel equipped with a magnetic stir bar. The resulting solution was cooled in a dry ice - isopropyl alcohol bath to -78° C., and Et₂Zn (0.5 mL of a 2 M solution in hexane, 1 mmol) was then added dropwise using a syringe and under an inert gas atmosphere. Initially the reaction was carried out at a reduced temperature and then it was allowed to gradually warm to ambient temperature and stirred at this temperature for additional 3 hours. After this time, the molecular structure of the resulting [EtZn—X]—type precursor (where X - monoanionic propionamide ligand) was confirmed by spectroscopic methods. In the next step, 1 mL of a 3% aqueous solution of H₂O₂ (1 mmol) was added dropwise to the in situ generated organozinc precursor cooled to the temperature of a dry ice - isopropyl alcohol cooling bath. Then the reaction mixture was allowed to gradually warm to room temperature and stirred at ambient temperature for one day. After this time, nanocrystalline ZnO₂ (from now on termed ZnO₂(13) NPs) was obtained in the form of a precipitate, which was isolated from the post-reaction mixture by centrifugation (9000 rpm, 10 minutes). Similar ZnO₂ NPs have been obtained using phthalimide, dicyclohexylurea and cysteine. The resulting sediment was then washed two times with a small portion of hexane (2 mL), re-centrifuged and dried under reduced pressure. The average core size of ZnO₂(13) NPs determined by PXRD (Error! Reference source not found.) is 2.48 ± 0.29 nm. Thermolysis of nanocrystalline ZnO₂(13) is a complex and multi-stage process. TGA profile shown in FIG. 29 exhibits a significant weight loss with a maximum decomposition rate at 193° C. (17.9% of weight loss corresponds to the transformation of ZnO₂ to ZnO as well as the removal of the residual water molecules) and the organic component decomposition is observed at higher temperatures.

### EXAMPLE 14

### Preparation of ZnO₂ NPs Coated With an Organic Shell Composed of Monoanionic Derivatives of 2,2-dimethyl-1-propanol

In the first step, 88 mg (1 mmol) of 2,2-dimethyl-1-propanol ((CH₃)₃CCH₂OH) or 182 mg (0.25 mmol) of [EtZn(OCH₂C(CH₃)₃)]₄ in 10 mL of THF was placed in a Schlenk vessel equipped with a magnetic stir bar and cooled in a dry ice - isopropyl alcohol bath. Et₂Zn (0.5 mL of a 2 M solution in hexane, 1 mmol) and 0.1 mL of perhydrol (1 mmol of H₂O₂) were then sequentially added dropwise using a syringe and under an inert gas atmosphere. Initially the reaction was carried out at out at the temperature of the cooling bath for ca. 15 minutes and then it was allowed to gradually warm to room temperature and stirred at this temperature for additional 24 hours. After this time, product as a precipitate falling to the vessel’s bottom was obtained and then purified according to the procedure described in Example 6. Based on PXRD, the reaction product was identified as nanocrystalline zinc peroxide (from now on termed ZnO₂(14) NPs) with a relatively small core size equal to 3.03 ± 0.10 nm (Error! Reference source not found.) and coated with organic shell (Error! Reference source not found.). DLS measurements for the colloidal solution of ZnO₂(14) NPs in DMSO confirmed the presence of associates with an average size of 133.6 nm and the polydispersity index equal to 0.161 (Error! Reference source not found.). The presence of IR band located in the area of 3300 cm⁻¹ corresponds to O—H stretching vibrations, which indicates the adsorption of water molecules and the parent alcohol on the surface of nanoparticles. Thermal decomposition shown in FIG. 33 also confirms the presence of water and/or alcohol content in the sample, however, the main decomposition step with a maximum decomposition rate at 212° C. could be ascribed to the quantitative transformation of ZnO₂ to ZnO.

### EXAMPLE 15

### Preparation of ZnO₂ NPs Coated with Triethylene Glycol Monomethyl Ether

164 mg (1 mmol) of triethylene glycol monomethyl ether (CH₃O(CH₂CH₂O)₃CH₂CH₂OH) in 10 mL of THF was placed in a Schlenk vessel equipped with a magnetic stir bar. The resulting solution was cooled in a dry ice - isopropyl alcohol bath to -78° C. Et₂Zn (0.5 mL of a 2 M solution in hexane, 1 mmol) and 0.1 mL of perhydrol were then sequentially added dropwise using a syringe and under an inert gas atmosphere. Initially the reaction was carried out at a reduced temperature and then it was allowed to gradually warm to room temperature and stirred at this temperature for additional 24 hours. Nanocrystalline zinc peroxide (ZnO₂(15) NPs) was obtained as a precipitate falling to the vessel’s bottom and then purified according to the procedure described in Example 6. The average size of nanocrystallites calculated from Scherrer’s formula is 2.29 ± 0.16 nm, and the lack of additional peaks on the diffraction pattern proves the high purity of the tested material (Error! Reference source not found.). DLS measurements confirmed that the solvodynamic diameter of ZnO₂ NPs dispersed in DMSO is 68.2 nm, which indicates the presence of small soft-type associates. The colloidal solution of ZnO₂(15) NPs is characterized by monodispersity (PdI ═ 0.095) and high stability both in organic solvents and in water (Error! Reference source not found.).

### EXAMPLE 16

### Preparation of ZnO₂ NPs Coated With N-(2-aminoethyl)-3-aminopropyltrimethoxysilane

222 mg (1 mmol) of N-(2-aminoethyl)-3-aminopropyltrimethoxysilane (C₈H₂₂N₂O₃Si₂) in 10 mL of THF was placed in a Schlenk vessel equipped with a magnetic stir bar. The resulting solution was cooled in a dry ice - isopropyl alcohol bath to -78° C. Et₂Zn (0.5 mL of a 2 M solution in hexane, 1 mmol) and 0.1 mL of perhydrol were then sequentially added dropwise using a syringe and under an inert gas atmosphere. Immediately after mixing the reactants (i.e., after ca. 5 seconds) the reaction mixture was allowed to gradually warm to ambient temperature and stirred for additional hour. The reaction product was obtained as a precipitate falling to the vessel’s bottom, which was then purified according to the procedure described in Example 6 and identified as nanocrystalline zinc peroxide (ZnO₂(16) NPs) (Error! Reference source not found.). Broadening of diffraction peaks indicates the relatively small size of the resulting nanocrystallites (d < 1 nm). Example 17.

### Preparation of ZnO₂ NPs in a Reaction Between Et₂Zn (99.9998%) and N-(2-aminoethyl)-3-aminopropyltrimethoxysilane and Perhydrol in a Molar Ratio of 1:2:2

167 mg (1 mmol) of N-(2-aminoethyl)-3-aminopropyltrimethoxysilane (C₈H₂₂N₂O₃Si₂) in 10 mL of THF was placed in a Schlenk vessel equipped with a magnetic stir bar. The resulting solution was cooled in a dry ice - isopropyl alcohol bath to -78° C. Et₂Zn (0.75 mL of a 2 M solution in hexane, 1.5 mmol) and 0.15 mL of perhydrol (1.5 mmol of H₂O₂) were then sequentially added dropwise using a syringe and under an inert gas atmosphere. Initially the reaction was carried out at -78° C. and then it was allowed to gradually warm to room temperature and stirred at this temperature for an additional one hour. The reaction product was obtained as a precipitate falling to the vessel’s bottom, which was then purified according to the procedure described in Example 6 and identified as nanocrystalline zinc peroxide (ZnO₂(17) NPs) (Error! Reference source not found. a) with a mean core size equal to 1.56 ± 0.24 nm. FTIR analysis revealed the presence of IR bands corresponding to the Si—O vibrations (1044, 1013 cm⁻¹) and thus confirmed the presence of the ligand shell on the surface of nanocrystalline ZnO₂ (Error! Reference source not found. b).

### EXAMPLE 18

### Preparation of ZnO₂ NPs Coated With Neutral Donor Ligands From the Group of Sulfoxides, Ketones and Ethers

78 mg (1 mmol) of dimethylsulfoxide ((CH₃)₂SO) in 10 mL of anhydrous THF was placed in a Schlenk vessel equipped with a magnetic stir bar. Et₂Zn (0.5 mL of a 2 M solution in hexane, 1 mmol) and 0.1 mL of perhydrol (1 mmol of H₂O₂) was then added dropwise using a syringe and under an inert gas atmosphere and the resulting solution was cooled in a dry ice - isopropyl alcohol bath to -78° C. Then 0.1 mL of 30% aqueous solution of H₂O₂ (1 mmol H₂O₂) was added dropwise to the system. Initially the reaction was carried out at the temperature of the cooling bath, which was removed after ca. 20 minutes, and then the reaction mixture was allowed to reach ambient temperature and stirred at this temperature for additional 24 hours. After this time, a stable suspension was obtained. In order to isolate ZnO₂, 5 mL of acetone was added to the post-reaction mixture and centrifugated (9000 rpm, 10 minutes). Then the resulting precipitate was washed with a small portion of acetone (2 mL), re-centrifuged and dried. Nanocrystalline zinc peroxide (ZnO₂(18) NPs) with a core size of 2.39 ± 0.22 nm was identified usig PXRD (Error! Reference source not found. a). The lack of additional peaks on the diffraction pattern proves the high purity of the tested product. FTIR analysis indicated the presence of —OH groups/water molecules and DMSO molecules coordinated to the surface of ZnO₂(18) NPs. The quantitative thermal decomposition of ZnO₂ into ZnO is at 196° C. (Error! Reference source not found. b). Similar results can be obtained using 1 mmol of acetone, fluoroacetone or diethyl ether, which also act as L-type stabilizing ligands, insted of dimethylsulfoxide.

### EXAMPLE 19

### Preparation of ZnO₂ NPs Coated With Triphenylphosphine or Triphenylphosphine Oxide Ligands

262 mg (1 mmol) of triphenylphosphine ((C₆H₅)₃P) or 278 mg (1 mmol) of triphenylphosphine oxide ((C₆H₅O)₃P) in 10 mL of anhydrous THF was placed in a Schlenk vessel equipped with a magnetic stir bar. Et₂Zn (0.5 mL of a 2 M solution in hexane, 1 mmol) and 0.1 mL of perhydrol (1 mmol of H₂O₂) were then sequentially added dropwise using a syringe at room temperature (ca. 22 - 27° C.) and under an inert gas atmosphere. The reaction mixture was stirred for one day. Then product was isolated from the post-reaction mixture and purified according to the procedure described in Example 6. PXRD data confirmed that nanocrystalline ZnO₂ (from now on termed ZnO₂(19) NPs) with a cubic crystal structure was obtained (Error! Reference source not found. a). Broadening of diffraction peaks indicates the relatively small size of the resulting nanocrystallites (d < 1 nm). FTIR analysis confirmed the presence of an organic shell composed of triphenylphosphine molecules as well as water molecules adsorbed of the surface of ZnO₂(19) NPs (Error! Reference source not found. b).

### EXAMPLE 20

### Preparation of ZnO₂ NPs Coated with N-[3-(trimethoxysilyl)propyl]ethylenediamine

In the first step, 222 mg (1 mmol) of N-[3-(trimethoxysilyl)propyl]ethylenediamine ((CH₃O)₃Si(CH₂)₃NHCH₂CH₂NH₂) in 10 mL of anhydrous THF was placed in a Schlenk vessel equipped with a magnetic stir bar. Then the resulting solution was cooled in a dry ice - isopropyl alcohol bath to -78° C. and Et₂Zn (0.5 mL of a 2 M solution in hexane, 1 mmol) was then added dropwise using a syringe and under an inert gas atmosphere. Initially the reaction was carried out at a reduced temperature and then it was allowed to gradually warm to room temperature and stirred at this temperature for additional 24 hours. After this time, the structure of the as-prepared product was confirmed by spectroscopic methods. In the next step, 0.1 mL of 30% aqueous solution of H₂O₂ (1 mmol) was added dropwise to the solution of the organozinc precursor cooled to the temperature of a dry ice - isopropyl alcohol cooling bath. Immediately after adding the oxidizing agent, the reaction mixture was warmed to room temperature and stirred at this temperature for additional 24 hours. Nanocrystalline ZnO₂ (from now on termed ZnO₂(20) NPs) in the form of a precipitate was isolated using centrifugation (9000 rpm, 10 minutes) and then washed with a small portion of hexane (2 mL), re-centrifugated and dried. The inorganic core of ZnO₂(20) NPs is characterized by a relatively small size of ca. 1 nm. (FIG. 40 a) and it is stabilized by an organic layer composed of N-[3-(trimethoxysilyl)propyl]ethylenediamine molecules, which can act simultaneously as L- and X-type ligands (Error! Reference source not found. b). Similar results have been obtained using phthalimide, urea or benzamide instead of N-[3-(trimethoxysilyl)propyl]ethylenediamine.

### EXAMPLE 21

### Preparation of ZnO₂ NPs Coated With Octylamine Ligands

129 mg (1 mmol) of octylamine (CH₃(CH₂)₇NH₂) in 10 mL of anhydrous THF was placed in a Schlenk vessel equipped with a magnetic stir bar. The resulting solution was cooled to -78° C. Et₂Zn (0.5 mL of a 2 M solution in hexane, 1 mmol) and 0.1 mL of perhydrol were then sequentially added dropwise using a syringe and under an inert gas atmosphere. Initially the reaction was carried out at a reduced temperature and then it was allowed to gradually warm to room temperature and stirred at this temperature for 1 hour. The reaction product was isolated and purified according to the procedure described in Example 6 and then identified as nanocrystalline ZnO₂ (ZnO₂(21) NPs) using PXRD (Error! Reference source not found.). The average core size of ZnO₂(21) nanoparticles is 2.15 ± 0.17 nm (Error! Reference source not found.) and the solvodynamic diameter measured in DMSO is 81.3 nm (PdI = 0.150) (Error! Reference source not found.). FTIR analysis (Error! Reference source not found.) confirmed the presence of an organic shell on the surface of nanocrystalline ZnO₂(21) NPs.

### EXAMPLE 22

### Preparation of ZnO₂ NPs Coated With a Two-Component Ligand Shell Composed of Monoanionic Derivatives of Phenylacetic Acid and 2,2-dimethyl-1-propanol

136 mg (1 mmol) of phenylacetic acid (C₇H₇COOH) and 88 mg (1 mmol) of 2,2-dimethyl-1-propanol in 10 mL of anhydrous THF was placed in a Schlenk vessel equipped with a magnetic stir bar. The resulting solution was cooled to -78° C. and Et₂Zn (1 mL of a 2 M solution in hexane, 2 mmol) and 0.2 mL of perhydrol (2 mmol of H₂O₂) were then sequentially added dropwise using a syringe and under an inert gas atmosphere. Initially the reaction was carried out at -78° C. for several minutes and then it was allowed to gradually warm to room temperature and stirred at this temperature for additional 24 hours. After this time, a colorless solution was obtained and nanocrystalline ZnO₂ (from now on termed ZnO₂(22) NPs) was precipitated using 5 mL of hexane and isolated from the post-reaction mixture by centrifugation (9000 rpm, 10 minutes). The resulting precipitate was washed with a small portion of hexane (2 mL), re-centrifuged and dried. PXRD analysis confirmed the nanocrystalline, cubic crystal structure of the resulting ZnO₂ with a crystallite size of 2.10 ± 0.15 nm (FIG. 44). DLS analysis indicated high monodispersity of these nanoparticles dispersed in THF (PdI = 0.108) and allowed to determine the solvodynamic diameter equal to 5.760 nm (FIG. 45). The presence of the two-component stabilizing layer was evidenced using FTIR (FIG. 46 a). The thermal decomposition of this material shown in na Error! Reference source not found. b indicates the transformation of ZnO₂ to ZnO at 212° C. (weight loss of 16%) and the decomposition of organic ligand shell at 433° C. (weight loss of 22%).

### EXAMPLE 23

### Preparation of ZnO₂ NPs Coated With a Two-Component Ligand Shell Composed of Monoanionic Derivatives of Phenylacetic Acid and 2,2-dimethyl-1-propanol From Two Homoligand Organozinc Precursors

In the first step, organometallic precursors were prepared according to the following procedure. 136 mg (1 mmol) of phenylacetic acid (C₇H₇COOH) and 88 mg (1 mmol) of 2,2-dimethyl-1-propanol in 10 mL of anhydrous THF were placed in a separate Schlenk vessels (100 cm³) equipped with a magnetic stir bars. Reagents were cooled in a dry ice - isopropyl alcohol bath to -78° C. and Et₂Zn (1 mL of a 2 M solution in hexane, 2 mmol) was then added dropwise to each vessel. Initially the reaction was carried out at out at the temperature of the cooling bath and then it was allowed to gradually warm to room temperature and stirred at this temperature for additional 2 hours. After this time, the entire volume of the reaction mixture containing the ethylzinc derivative of phenylacetic acid was transferred to the reaction mixture containing the ethylzinc derivative of 2,2-dimethyl-1-propanol using a disposable syringe and under inert conditions. Similar results could be obtained by using the appropriate amounts of the respective crystalline organozinc precursors, i.e., [EtZn(O₂H₇C₈)]ₙ and [EtZn(OCH₂C(CH₃)₃)]₄ dissolved in the appropriate amount of an organic solvent (THF or toluene). The mixture with a final volume of 10 mL was stored at room temperature for additional 24 h. After this time, 0.2 mL of perhydrol (2 mmol of H₂O₂) was added to the reaction mixture cooled to -78° C. Then the reaction system was allowed to gradually warm to room temperature and left at this temperature for 24 hours (in the case of toluene, the reaction were carried out at 40° C. for 8 hours). The as-prepared ZnO₂ nanoparticles are similar to ZnO₂(22) NPs.

### EXAMPLE 24

### Preparation of ZnO₂ NPs Coated With a Two-Component Ligand Shell Composed of Monoanionic Derivatives of Phenylacetic Acid and 2,2-dimethyl-1-propanol From Two Heteroligand Organozinc Precursors

136 mg (1 mmol) of phenylacetic acid (C₇H₇COOH) and 88 mg (1 mmol) of 2,2-dimethyl-1-propanol in 10 mL of anhydrous THF was placed in a Schlenk vessel equipped with a magnetic stir bar. Reagents were cooled in a dry ice - isopropyl alcohol bath to -78° C. and Et₂Zn (1 mL of a 2 M solution in hexane, 2 mmol) was then added dropwise. Initially the reaction was carried out at the temperature of the cooling bath for ca. 1 hour and then the reaction mixture was allowed to gradually warm to room temperature and stirred at this temperature for additional 2 hours. After this time, the molecular structure of the resulting product in the form of heteroligand organozinc compound was confirmed by spectroscopic methods. In the next step, 0.1 mL of 30% aqueous solution of H₂O₂ (2 mmol) was added dropwise to the as-prepared organozinc precursor solution cooled to the temperature of a dry ice - isopropyl alcohol cooling bath. Then the reaction mixture was allowed to gradually warm to room temperature (ca. 3 h) and stirred at ambient temperature for additional 24 hours. In the above reaction, a product similar to ZnO₂(22) NPs was obtained.

### EXAMPLE 25

### Preparation of ZnO₂ NPs Coated with a Two-Component Ligand Shell Composed Of Monoanionic Derivatives of Phenylacetic Acid and Octylamine

136 mg (1 mmol) of phenylacetic acid (C₇H₇COOH) and 129 mg (1 mmol) of octylamine in 10 mL of THF was placed in a Schlenk vessel equipped with a magnetic stir bar. The resulting solution was cooled in a dry ice - isopropyl alcohol bath to -78° C. Et₂Zn (0.5 mL of a 2 M solution in hexane, 2 mmol) and 0.1 mL of 75% aqueus solution of H₂O₂ (2 mmol) were then sequentially added dropwise using a syringe and under an inert gas atmosphere. Initially the reaction was carried out at -78° C. for ca. 10 minutes and then it was allowed to gradually warm to ambient temperature and stirred at this temperature for additional 24 hours. After this time, a colorless solution was obtained. The reaction product was purified according to the method described in Example 6 and identified as nanocrystalline zinc peroxide (from now on termed ZnO₂(23) NPs) wit a core size equal to 2.06 ± 0.17 nm (Error! Reference source not found.) and solvodynamic diameter equal to 4.79 nm (PdI = 0.123) (Error! Reference source not found.). FTIR analysis shown in FIG. 49 confirmed the presence of an organic shell attached to the surface of nanocrystalline ZnO₂ and composed of phenylacetate ligands (1567 and 1376 cm⁻¹ bands corresponding to the vibration of the C—O carboxylate group) and octylamine molecules (the presence of 2919 and 2831 cm⁻¹ bands corresponding to the C—H vibration of the aliphatic chain). Thermogravimetric analysis shows the transformation of ZnO₂ to ZnO at 203° C.

### EXAMPLE 26

### Preparation of ZnO₂ NPs coated with a Two-Component Ligand Shell Composed of Octylamine and Triphenylphosphine

129 mg (1 mmol) of octyalmine and 262 mg (1 mmol) of triphenylphosphine in 10 mL of anhydrous THF (the usage of water-containing solvent does not affect the properties of the resulting) was placed in a Schlenk vessel equipped with a magnetic stir bar. The resulting solution was cooled in a dry ice - isopropyl alcohol bath to -78° C. Et₂Zn (0.5 mL of a 2 M solution in hexane, 2 mmol) and 0.2 mL of 30% aqueous solution of H₂O₂ (2 mmol) were then sequentially added dropwise using a syringe and under an inert gas atmosphere. Then the reaction mixture was allowed to gradually warm to room temperature and stirred at this temperature for additional 24 hours. The reaction product was isolated and then purified according to the method described in Example 6. The presence of nanocrystalline ZnO₂ (from now on termed ZnO₂(24) NPs) with a mean core size equal to 1.97 ± 0.22 nm was confirmed using PXRD. The composition of the organic shell was determined on the basis of the IR spectrum shown in FIG. 50. Qualitative analysis confirmed the presence on the surface of ZnO₂(24) NPs both coordinated octylamine (a wide and diffuse band at 3350 cm⁻¹ along with a set of bands at 2984 cm⁻¹, 2926 cm⁻¹ and 2853 cm⁻¹ atributed to N—H and aliphatic C—H vibration, respectively), as well as triphenylphosphine (characteristic P—C bond vibration at 536 cm⁻¹) molecules.

### EXAMPLE 27

### Preparation of ZnO₂ NPs in a Reaction Between R₂Zn (R = Et, Cy) and Peracetic Acid

0.2 mL (1 mmol) of peracetic acid solution (concentration = 40%; CH₃COOOH) in 10 mL of THF was placed in a Schlenk vessel equipped with a magnetic stir bar. The resulting solution was cooled in a dry ice - isopropyl alcohol bath to -78° C. Et₂Zn (0.5 mL of a 2 M solution in hexane, 2 mmol) or Cy₂Zn (1 mL of a 1 M solution in toluene, 1 mmol) was then added dropwise using a syringe and under an inert gas atmosphere. The reaction was carried out at -78° C. for ca. 40 minutes and then the reaction mixture was allowed to gradually warm to room temperature and stirred at this temperature for additional 1 hour. The resulting product in the form of sediment was purified according to the method described in Example 6. As a result, nanocrystalline ZnO₂ (from now on termed ZnO₂(25) NPs) was obtained and then the crystal structure of the resulting product was confirmed using PXRD (Error! Reference source not found. a). The average core size of ZnO₂(25) is equal to 2.20 ± 0.15 nm, and FTIR analysis indicates the presence of acetate ligands bound to the surface of the as-prepared nanoparticles (Error! Reference source not found. b). Nanocrystalline ZnO₂(25) decomposes into ZnO at 210° C. (with a total weight loss of ca. 15.4%), which is shown in Error! Reference source not found..

### EXAMPLE 28

### Annealing of ZnO₂(3) NPs and its Transformation Into Nanocrystalline ZnO

20 mg of ZnO₂ NPs prepared according to the procedure described in Example 3 was placed in a glass vial and introduced into an oven pre-heated to a temperature of 200° C. The material was annealed at this temperature for 30 minutes. This process can be carried out both under anaerobic and aerobic conditions, without affecting the properties of the final product. The resulting material was allowed to gradually cool down to ambient temperature and characterized using PXRD. PXRD analysis revealed the presence of nanocrystalline ZnO with a wurtzite-type crystal structure and a crystallite size of 7.57 ± 0.94 nm (Error! Reference source not found.). The as-prepared ZnO NPs exhibit fluorescent properties both in the solid state as well as dispersed in a selected organic solvent. TEM micrographs of the resulting ZnO nanoparticles as well as their size distribution are shown in Error! Reference source not found.. The micrographs show single quasi-spherical ZnO nanocrystallites with a core size of a few nanometers (ca. 3.5 - 12 nm) as well as their bigger aggregates. Both the time and the temperature of annealing are parameters that should be adjusted to the starting ZnO₂-type material and the values presented in this example are optimal for a larger group of nanocrystalline forms of ZnO₂ (note that the annealing temperature should be in the range from 100° C. to 1000° C. and the time in the range from 1 minutes to 48 hours).

### EXAMPLE 29

### Grinding of ZnO₂(3) NPs in a Ball Mill

100 mg of ZnO₂ NPs and steel ball with a diameter of 1 cm, acting as the grinding element, were placed in a steel ball mill with a capacity of 15 cm³. The mechanochemical transformation was carried out at a frequency of 30 Hz for 30 minutes (the mechanosynthesis process can be carried out both under anaerobic and aerobic conditions, since it does not affect the properties of the final product). Then the as-prepared product in the form of a white solid exhibiting luminescent under UV light irradation was characterized using PXRD. PXRD analysis confirmed the presence of both nanocrystalline ZnO with a wurtzite-type crystal structure and the residual phase of nanocrystalline zinc peroxide (FIG. 55). The applied transformation time can easily control the ZnO phase content in the final product. These results indicate that ZnO₂ nanoparticles are effective single-source inorganic precursor of ZnO nanostructures.

### EXAMPLE 30

### Annealing of ZnO₂(5) NPs and its Transformation Into Nanocrystalline ZnO

20 mg of ZnO₂ NPs prepared according to the procedure described in Example 5 was placed in a glass vial and introduced into an oven pre-heated to a temperature of 200° C. The material was annealed at this temperature for 1 hour. As a result of high temperature treatment, the powder changed its color from light yellow to brown, which evidences, among others, partial degradation or the condensation reaction of the ligand on the NPs surface. The resulting material was gradually cool down to ambient temperature and characterized using PXRD (Error! Reference source not found. a). The resulting ZnO NPs exhibit fluorescence both in the solid state as well as dispersed in a selected organic solvent. Despite the partial decomposition of the organic layer, FTIR analysis (Error! Reference source not found. b) confirmed the presence of urea or its deriveatised in the tetsted material.

### EXAMPLE 31

### Annealing of ZnO₂(6) NPs and its Transformation Into Nanocrystalline ZnO

20 mg of ZnO₂ NPs prepared according to the procedure described in Example 6 was placed in a glass vial and introduced into an oven pre-heated to a temperature of 180° C. The material was annealed at this temperature for 30 minutes and then allowed to reach ambient temperature. As a result of high temperature treatment, the powder changed its color from white to dark gray, which evidences, among others, partial degradation of the ligand on the NPs surface. The resulting product was cheracterized using PXRD. Diffractogram analysis indicated the presence of the nanocrystalline, wurtzite-type ZnO structure with a crystallite size of 7.31 ± 0.3 nm (Error! Reference source not found. a). The lack of diffraction pattern characteristic for the ZnO₂ phase proves the complete decomposition of ZnO₂ NPs into ZnO. Despite the partial decomposition of the organic layer, FTIR analysis confirmed the presence of an organic shell composed of deprotonated butyric acid molecules on the surface of nanocrystalline ZnO core (Error! Reference source not found. b), which is evidenced by the presence of relatively weak IR bands characteristic for the carboxylate ligands bound to the nanoparticles surface (1557 cm⁻¹ and 1410 cm⁻¹).

### EXAMPLE 32

### Annealing of ZnO₂(8) NPs and its transformation into nanocrystalline ZnO

20 mg of ZnO₂ NPs prepared according to the procedure described in Example 8 was placed in a glass vial and introduced into an oven pre-heated to a temperature of 200° C. The material was annealed at this temperature for 30 minutes and then allowed to reach ambient temperature. The resulting product was cheracterized using PXRD (Error! Reference source not found. a). Diffractogram analysis indicated the presence of the nanocrystalline, wurtzite-type ZnO structure with a crystallite size of 3.35 ± 0.58 nm as well as the lack of diffraction pattern characteristic for the ZnO₂. FTIR analysis confirmed the presence of an organic shell composed of deprotonated phenylacetate acid molecules on the surface of nanocrystalline ZnO core (Error! Reference source not found. b), which is evidenced by the presence of two bands characteristic for COO⁻ group (1544 cm⁻¹ and 1398 cm⁻¹).

### EXAMPLE 33

### Annealing of ZnO₂(25) NPs and its Transformation Into Nanocrystalline ZnO

20 mg of ZnO₂(25) NPs prepared according to the procedure described in Example 27 was placed in a glass vial and introduced into an oven pre-heated to a temperature of 400° C. The material was annealed at this temperature for 20 minutes (similar results can be obtained by changing both the time and the temperature of annealing, while the annealing temperature should not be lower than 100° C.). Then the resulting material was allowed to gradually reach ambient temperature and was cheracterized using PXRD. Diffractogram analysis (Error! Reference source not found. a) indicated the presence of the nanocrystalline, wurtzite-type ZnO structure with a crystallite size of 7.03 ± 1.06 nm. The lack of diffraction pattern characteristic for the ZnO₂ phase proves the complete decomposition of ZnO₂ NPs into ZnO. The resulting ZnO NPs exhibit fluorescence properties both in solid state and dispersed in selected organic solvent. Absorption and emission spectra of the dispersion of ZnO NPs in DMSO are shown in Error! Reference source not found. b. ZnO NPs reveald a broad absorption with a maximum located at λ = 343 nm and characteristic for ZnO emission centered at λ = 567 nm (Error! Reference source not found. b). FTIR analysis confirmed the presence of an organic shell composed of deprotonated acetic acid molecules on the surface of nanocrystalline ZnO core.

### EXAMPLE 34

### Preparation of ZnO₂ NPs in a Reaction Between Et₂Zn and H₂O₂ in in a Solvent with Coordinating Properties

5 mL of dimethylsulfoxide (water-containing commercially available DMSO was used as received, i.e, without purification) was placed in a Schlenk vessel equipped with a magnetic stir bar. Et₂Zn (0.5 mL of a 2 M solution in hexane, 1 mmol) and 3 mL of 1% aqueus solution of H₂O₂ (1 mmol) were then sequentially added dropwise via a syringe at ambient temperature and under an inert gas atmosphere. The oxidizing agent was added in small portions for about an hour. Then the reaction mixture was stirred at ambient temperature for 24 hours. After this time, a fluorescent suspension was obtained. Afterwards 5 mL of acetone was added to the reaction mixture and the resulting precipitate was separated by centrifugation (9000 rpm, 10 minutes), washed with acetone (2 mL), re-centrifuged and dried. PXRD analysis (Error! Reference source not found. a) confirmed the nanocrystalline wurtzite-type structure of ZnO NPs. The average size of nanocrystallites is 9.23 ± 1.6 nm, and the lack of additional peaks on the diffraction pattern proves the high purity of the tested sample. Absorption and emission spectra of the dispersion of ZnO NPs in DMSO are shown in Error! Reference source not found.. FTIR analysis confirmed the presence of an organic layer composed of DMSO and/or water molecules on the surface of nanocrystalline ZnO (Error! Reference source not found. b).

### EXAMPLE 35

### Preparation of ZnO₂ NPs in a Reaction Between Et₂Zn and Na₂CO₃·1.5H₂O₂ in a Molar Ratio of 0.75:1 (the Molar Ratio of the Organozinc Precursor to H₂O₂ is 1:2)

157 mg (1 mmol) of sodium percarbonate (Na₂CO₃·1.5H₂O₂) in 10 mL of anhydrous THF or in THF/hexane mixture was placed in a Schlenk vessel equipped with a magnetic stir bar. The resulting solution was cooled in a dry ice - isopropyl alcohol bath to -78° C. Et₂Zn (0.75 mL of a 2 M solution in hexane, 1 mmol) was then added dropwise via a syringe at ambient temperature and under an inert gas atmosphere. The reaction was carried out at -78° C. for several minutes and then the reaction mixture was allowed to spontaneously warm to ambient temperature and stirred at this temperature for additional 24 hours. The resulting sediment showed luminescent properties immediately after air exposure and under UV light irradiation. The resulting product was purified by washing two times with small portions of ethanol and then isolated from the reaction mixture by centrifugation (9000 rpm, 10 minutes). The product in form of white solid (Error! Reference source not found. a) was identified as the nanocrystalline wurtzite-type crystal structure of ZnO NPs with a core size equal to 6.16 ± 0.60 nm using PXRD. The lack of additional peaks on the diffraction pattern proves the acceptable purity of the tested sample. The as-prepared NPs revealed a broad and well-formed absorption band with a maximum at λ = 337 nm and relatively broad emission band with a maximum in the visible light range λₑₘ = 540 nm (Error! Reference source not found. b).

### EXAMPLE 36

### Preparation of ZnO₂ NPs in a Reaction Between R₂Zn (R = Et, Me) and Na₂CO₃·1.5H₂O₂ in a Molar Ratio of 1:2 (the Molar Ratio of the Organozinc Precursor to H₂O₂ is 1:3)

315 mg (2 mmol) of sodium percarbonate (Na₂CO₃·1.5H₂O₂) in 10 mL of anhydrous THF was placed in a Schlenk vessel equipped with a magnetic stir bar. The resulting solution was cooled in a dry ice - isopropyl alcohol bath to -78° C. Et₂Zn (0.5 mL of a 2 M solution in hexane, 1 mmol) or Me₂Zn (1 mL of 1 M solution in toluene, 1 mmol) was then added dropwise via a syringe and under an inert gas atmosphere. The reaction was carried out at -78° C. for several minutes and then the reaction mixture was allowed to spontaneously warm to ambient temperature and stirred at this temperature for additional 24 hours. The resulting precipitate was separated from the post-reaction mixture and purified according to the procedure described in Example 35 and it was identified as nanocrystalline ZnO with a wurtzite-type crystal structure (FIG. 63) using PXRD. Additional diffraction peaks indicate a high degree of contamination of the sample with unreacted sodium percarbonate, which was also confirmed by the presence of characteristic bands in the IR spectrum (Error! Reference source not found. b). Absorption and emission spectra of the ZnO-type product dispersed in DMSO are shown in Error! Reference source not found..

### EXAMPLE 37

### Testing the Stability of ZnO₂(3) NPs in Solutions With Different pH Values - a Method of Preparation of ZnO by ZnO₂ Dispersing in a Solution With a Reduced pH

Nanocrystalline zinc peroxide - ZnO₂(3) NPs — prepared according to the procedure described in Example 3 was placed in 5 glass vials (50 mg each) with a capacity of 25 mL and equipped with magnetic stir bars. Then 10 mL of deionized water (MilliQ) with different pH values (i.e., 6; 6.5; 7; 7.5; 8) was added to each vial and the resulting mixtures were stirred for additional 24 h. After this time, all samples were centrifugated (9000 rpm, 5 min), and the resulting sediments were dried. The as-prepared materials were characterized using PXRD (FIG. 65). Thus, it can be concluded that nanocrystalline zinc peroxide prepared by the organometallic approach is stable and does not decompose in an alkaline environment, but it decomposes into nanocrystalline zinc oxide at pH ≤ 7.5. Storage of ZnO₂ NPs in a solution with an appropriate pH (pH ≤ 7.5) for 24 hours or longer leads to the formation of nanocrystalline ZnO with a wurtzite-type crystal structure and a core diameter smaller than 15 nm.

### EXAMPLE 38

### Preparation of ZnO₂ NPs in a Reaction Between Et₂Zn and Ozone

Et₂Zn (1 mL of a 1 M solution in hexane, 1 mmol) was added dropwise to 10 mL of THF placed in a Schlenk vessel, vigorously stirred with a magnetic stir bar and cooled to -20° C. (an ice bath with a sodium chloride was used). Subsequently, the reaction vessel was connected to an ozone generator (ozone production was 3.5 g/h) and exposed to ozone for 3 minutes. Then the reaction mixture was allowed to gradually warm to room temperature and stirred at this temperature for additional 24 hours. The resulting product in the form of a precipitate was washed two times with small portions of hexane (2 mL), isolated using centrifugation (9000 rpm, 10 minutes) and dried. Nanocrystalline ZnO was obtained and the crystal structure of the resulting product was confirmed using PXRD (Error! Reference source not found.). The average size of ZnO nanocrystallites is 3.70 ± 0.48 nm. Similar results have been obtained using dimethylzinc or by dissolving 220 mg of Ph₂Zn (1 mmol) in 20 mL of toluene or THF.

### EXAMPLE 39

### Preparation of ZnO₂ NPs Using Solvent-Free Approach (the Molar Ratio of the Organozinc Precursor to H₂O₂ is 1:2)

220 mg of Ph₂Zn (1 mmol) or 400 mg of (C₆F₅)₂Zn (1 mmol) and 282 mg of hydrogen peroxide-urea adduct (CO(NH₂)₂·H₂O₂) and steel ball with a diameter of 1 cm, acting as the grinding element, were placed in a steel ball mill with a capacity of 15 cm³ under an inert gas atmosphere. The mechanochemical transformation was carried out at a frequency of 30 Hz for 30 minutes. Thus product as a black solid was obtained. PXRD analysis confirmed the presence of a nanocrystalline zinc peroxide phase stabilized with urea resulting from the hydrogen peroxide-urea adduct decomposition (FIG. 67). Similar results have been obtained using other solid-state reagents, i.e., di-tert-butyl zinc and dicyclopentadienylzinc. Moreover, the mechanosynthesis could be carried out using the LAG method (i.e., liquid-assisted grinding) by adding 50 µl, 100 µl or 150 µl of a solvent, for example, hexane, DMSO, toluene, dioxane, or mixtures thereof.

### EXAMPLE 40

### Bacteriostatic Properties of ZnO₂ NPs

Magnetic stir bars and 10 mg of selected nanocrystalline zinc peroxide - i.e., ZnO₂(3) NPs (sample marked as 1), ZnO₂(9) NPs (sample marked as 10) and ZnO₂(15) NPs (sample marked as 19), which were prepared according to the procedures described in Example 3, Example 9 and Example 15, respectively - were placed in glass vials of the capacity of 25 mL. Then 10 mL of deionized water (MilliQ) with different pH values (i.e., 6 and 7) was added to each vial and the resulting mixtures were stirred for additional 24 h. Additional solutions with concentrations ranges from 5 µg/mL to 100 µg/L were prepared by the method of successive dilutions. Microbiological tests were performed using the disc diffusion method. In order to determine the bacteriostatic/bactericidal properties of ZnO₂ NPs against gram(+) - Staphylococcus aureus and gram(-) - Pseudomonas aeruginosa bacteria, the materials selected for tests in the form of an aqueous solution with a specific pH were spotted on a filter paper (350 µl) and then the as-obtained disc was placed on a plate inoculated with bacterial isolate. Tests were performed for the nanomaterial concentration from 5 µg/mL to 100 µg/L in solutions with a pH of 6 and 7. The representative results are shown in FIG. 68. Bacterial growth was not observed directly under the paper discs impregnated with ZnO₂ NPs, which indicates the utility of the tested nanoparticles as antibacterial/bacteriostatic materials.

### EXAMPLE 41

### Antibacterial Properties of Surfaces Coated by ZnO₂ NPs

Magnetic stir bars and 10 mg of selected nanocrystalline zinc peroxide - ZnO₂(1) NPs and ZnO₂(16) NPs, which were prepared according to the procedures described in Example 1 and Example 16, respectively - were placed in glass vials of the capacity of 25 mL. Then 10 mL of deionized water (MilliQ) was added for each vial and sonicated for 10 minutes. Additional solutions with concentrations of 1 mg/mL (for ZnO₂(16) NPs) and 10 mg/mL (for ZnO₂(1) NPs and for ZnO₂(16) NPs) were prepared by the method of successive dilutions. The antibacterial properties of the tested nanomaterials were determined in accordance with the ISO 22196:2011/JIS Z 2801:2010 test method. ZnO₂ NPs in the form of aqueous solutions with a specific concentration were evenly applied in the form of a thin layer on the entire surface of a sterile glass square plates (5 cm x 5 cm). Then as-prepared plates were dried at 40° C. The whole process was repeated three times, and the total volume of material suspension applied on each glass plate was 1 mL. For each bacterial strain (i.e., gram(+) - Staphylococcus aureus, gram(-) -Pseudomonas aeruginosa and gram(-) - Escherichia coli) the inoculum was prepared as described in the test method. Inoculum concentration ranged between 2.5 × 10⁵ and 1.0 × 10⁶ CFU/mL. Each test sample (both control samples that are not covered with any material and those that contain a tested nanomaterial layer) was inoculated with 0.4 mL of the inoculum. Then the as-prepared samples were covered with sterile plastic in order to ensure direct contact between viable bacteria and tested nanomaterial. Control sample, immediately after inoculation, was washed using neutralizing solution (broth SCDLP) in a volume of 10 mL per sample and then plated on the propagation medium at serial dilutions from 10⁰ do 10⁻⁴. Thest samples were incubated for 24 h at 35° C. and a relative humidity of not lover than 90%. After this time, samples were washed with a neutralizing solution and plated on the propagation medium at dilutions from from 10⁰ do 10⁻⁴. The study was carried out in triplicate, separately for each of the mentioned bacterial strains. After 72 h of incubation, bacterial colonies were counted for each test sample and the survival of bacterial cells on each of the test samples was calculated according to the formulas described in ISO 22196/JIS Z 2801 test method. The value of antibacterial activity (R) was calculated according to the formulaR = Bₜ — Cₜ (where: Bₜ— average of logarithm numbers of viable bacteria from control sample at time = 24 hour; Cₜ— average of logarithm numbers of viable bacteria from treated sample at time = 24 hour). According to the ISO 22196/JIS Z 2801 standard sufficient antibacterial effectiveness is reached when the antibacterial activity (R) is rated 2 or more. Both ZnO₂(1) NPs and ZnO₂(16) NPs show a very good antibacterial effectiveness against selected bacterial strains (i.e., R is equal to 6.04 (S. aureus), 6.20 (E. coli) and 6.49 (P. aeruginosa) and R is equal to 7.84 (S. aureus), 7.53 (E . coli) and 6.43 (P. aeruginosa) for ZnO₂(1) and ZnO₂(16) NPs) concentration of 10 mg/mL, respectively). In addition, ZnO₂(16) NPs at concentration of 1 mg/mL is also characterized by a very good antibacterial effectiveness against P. aeruginosa (R = 8.93) and S. aureus (R = 3.39).

### EXAMPLE 42

### Biocidal Properties of ZnO₂(16) NPs According to the Modified Koch Sedimentation Test

ZnO₂ nanoparticles were prepared according to the procedure described in Example 16 and prepared for testing according to the method described in Example 41. The biocidal properties of ZnO₂ were determined by comparing the number of viable bacterial/fungal cells deposited from the air on the surface of sterile glass square plates (5 cm x 5 cm) protected with a thin layer of ZnO₂(16) NPs and on a control (uncovered) plates. Material was applied to the glass square plates according to the procedure described in Example 41. The as-prepared test samples (both control samples and those that contain a tested nanomaterial layer) were placed in sterile Petri dishes and left in the room for the specified time (in this study, three different exposure times of 5, 30 and 60 minutes, respectively, were carried out). Immediately after exposure, the samples were washed with a neutralizing solution (SCDLP broth) in a volume of 10 mL per sample and plated on bacterial and fungal media at serial dilutions from 10⁰ to 10⁻⁴. After 72 h of incubation, bacterial/fungal colonies were counted for each test sample and the number of microbial cells was calculated per 1 m³ of air. The value of the antibacterial efectiveness was determined according to the formula: L = a × 1000 / B × k (where: L: average number of bacterial/fungal cells deposited on the plate per 1 m³ of air; R: number of microorganisms in 1 m³ of air; a: number of colonies microorganisms grown on appropriate media; B: area of the tested material sample [cm²]; k: exposure time factor of the tested material; k = t (exposure time in minutes) × ⅕. Results (L < 10 for all tested cases, where L - the average number of bacterial/fungal cells deposited on the plate per 1 m³ of air; data averaged for three different exposure times) confirm that ZnO₂(16) NPs show strong antimicrobial effect on the surface exposed to free deposition of bacteria and fungi from the air.

### LITERATURA

¹ W. Chen, Y. H. Lu, M. Wang, L. Kroner, H. Paul, H.-J. Fecht, J. Bednarcik, K. Stahl, Z. L. Zhang, U. Wiedwald, U. Kaiser, P. Ziemann, T. Kikegawa, O C. D. Wu, J. Z. Jiang. Synthesis, Thermal Stability and Properties of ZnO₂ Nanoparticles. J. Phys. Chem. C 2009, 113, 1320 - 1324.

² H. Bai, X. Liu, Green hydrothermal synthesis and photoluminescence property of ZnO₂ nanoparticles. Mater. Lett. 2010, 64, 341 - 343.

³ R. D. Iyengar, V. V. S. Rao, Electron Spin Resonance Studies on Zinc Peroxide and on Zinc Oxide Obtained from a Decomposition of Zinc Peroxide. J. Phys. Chem. 1971, 75, 3089 - 3092.

⁴ A. Escobedo-Morales, R. Esparza, A. Garcia-Ruiz, A. Aguilar, E. Rubio-Rosas, R. Pérez, Structural and vibrational properties of hydrothermally grown ZnO₂ nanoparticles. J. Cryst. Growth 2011, 316, 37 - 41.

⁵ Y. C. Zhang, X. Wu, X. Ya Hu, R. Guo, Low-temperature synthesis of nanocrystalline ZnO by thermal decomposition of a “green” single-source inorganic precursor in air. J. Cryst. Growth 2005, 280, 250 - 254.

⁶ X. Han, R. Liu, W. Chen, Z. Xu, Properties of nanocrystalline zinc oxide thin films prepared by thermal decomposition of electrodeposited zinc peroxide. Thin Solid Films 2008, 516, 4025 -4029.

⁷ C. Bergs, L. Brück, R. R. Rosencrantz, G. Conrads, L. Elling, A. Pich, Biofunctionalized zinc peroxide (ZnO₂) nanoparticles as active oxygen sources and antibacterial agents. RSC Adv. 2017, 7, 38998 - 39010.

⁸ (a) L. Ibarra, M. Alzorriz, Effect of temperature on the crosslink densities of nitrile rubber and carboxylated nitrile rubber with zinc peroxide. J. Appl. Polym. Sci. 2002, 86, 335 - 340; (b) L. Ibarra, M. Alaorriz, Ionic elastomers based on carboxylated nitrile rubber (XNBR) and zinc peroxide: Influence of carboxylic group content on properties. J. Appl. Polym. Sci. 2002, 84, 605 - 615.

⁹ B. A. Johnson, F.L. Meleney, The antiseptic and detoxifying action of zinc peroxide on certain surgical aerobic, anaerobic and micro-aerophilic bacteria. Ann Surg. 1939, 109, 881 - 911 and references therein.

¹⁰ F. L. Meleney, Present role of zinc peroxide in treatment of surgical infections. J. Am. Med. Assoc. 1952, 149, 1450 - 1453.

¹¹R. Colonia, J. L. Solís, M. Gómez, Bactericidal, structural and morphological properties of ZnO₂ nanoparticles synthesized under UV or ultrasound irradiation. Adv. Nat. Sci. Nanosci. Nanotechnol. 2013, 5, 015008.

¹²L. E. Román, D. Maurtua, F. Paraguay-Delgado, J. L. Solís, M. M. Gómez, Green synthesis of ZnO₂ nanoparticles and their annealing transformation into ZnO nanoparticles: characterization and antimicrobial activity. J. Nanosci. Nanotechnol. 2016, 16, 9889 - 9895.

¹³ S. S. Ali, R. Morsy, N. A. El-Zawawy, M. F. Fareed, M. Y. Bedaiwy, Synthesized zinc peroxide nanoparticles (ZnO₂—NPs)— A novel antimicrobial, anti-elastase, anti-keratinase, and antiinflammatory approach toward polymicrobial burn wounds. Int. J. Nanomedicine 2017, 12, 6059 - 6073.

¹⁴ S. Ahtzaz, M. Nasir, L. Shahzadi, W. Amir, A. Anjum, R. Arshad, F. Iqbal, A. A. Chaudhry, M. Yar, I. Rehman, A study on the effect of zinc oxide and zinc peroxide nanoparticles to enhance angiogenesis-pro-angiogenic grafts for tissue regeneration applications. Mater. Des. 2017, 132, 409 - 418.

¹⁵ L.-S. Lin, J.-F. Wang, J. Song, Y. Liu, G. Zhu, Y. Dai, Z. Shen, R. Tian, J. Song, Z. Wang, W. Tang, G. Yu, Z. Zhou, Z. Yang, T. Huang, G. Niu, H.-H. Yang, Z.-Y. Chen, X. Chen, Cooperation of endogenous and exogenous reactive oxygen species induced by zinc peroxide nanoparticles to enhance oxidative stress-based cancer therapy. Theranostics 2019, 9, 7200 - 7209.

¹⁶ R. Hagel, K. Redecker, Use of zinc peroxide as oxidant for explosive and pyrotechnical mixtures. 1982, United States Patent (US 4,363,679); 1984, European Patent Office (EP0031045B1).

¹⁷ S. Chawla, H. Uppal, M. Yadav, N. Bahadur, N. Singh, Zinc peroxide nanomaterial as an adsorbent for removal of Congo red dye from waste water. Ecotoxicol. Environ. Saf. 2017, 135, 68 - 74.

¹⁸(a) M. A. Gondal, Q. Ahmed, Q. Drmosh, Z. H. Yamani, T. A. Saleh, Method of forming zinc peroxide nanoparticles. 2011, United States Patent (US 2011/0303050 A1); (b) M. A. Gondal, Q. Ahmed, Q. Drmosh, Z. H. Yamani, T. A. Saleh, Method for detection of cyanide in water. 2011, United States Patent (US 2011/0303555A1).

¹⁹ N. Singh, S. Rashmi Singh, R. Pasricha, D. Soni, P. K. Gupta, D. Soni, Process for preparing zinc peroxide nanoparticles. 2014, United States Patent (US 8,715,612 B2).

²⁰ D. A. Giannakoudakis, M. Florent, R. Wallace, J. Secor, C. Karwacki, T. J. Bandosz, Zinc peroxide nanoparticles: Surface, chemical and optical properties and the effect of thermal treatment on the detoxification of mustard gas. Appl. Catal. B Environ. 2018, 226, 429 - 440.

²¹ C.-C. Hsu, N. L. Wu, Synthesis and photocatalytic activity of ZnO/ZnO₂ composite. J. Photochem. Photobiol. A 2005, 172, 269 - 274.

²² M. Guo, L. Li, H. Lin, Y. Zuo, X. Huang, G. Li, Targeted deposition of ZnO₂ on brookite TiO₂ nanorods towards high photocatalytic activity. Chem. Commun. 2013, 49, 11752 - 11754.

²³ Q. Guo, Q. Zhang, H. Wang, Z. Zhao, ZnO₂-promoted ZnO as an efficient photocatalyst for the photoreduction of carbon dioxide in the presence of water. Catal. 2018, 103, 24 - 28.

²⁴ D. Sebök, I. Dékány, ZnO₂ nanohybrid thin film sensor for the detection of ethanol vapour at room temperature using reflectometric interference spectroscopy. Sens. Actuator B-Chem. 2015, 206, 435 - 442.

²⁵ F. M. Simanjuntak, S. Chandrasekaran, C.-C. Lin, T.-Y. Tseng, Switching failure mechanism in zinc peroxide-based programmable metallization cell. Nanoscale Res. Lett. 2018, 13, 327.

²⁶ S. Verma, S. L. Jain, Nanocrystalline zinc peroxide mediated unprecedented nitrene transfer: An expeditious access to N-tosylaziridines. RSC Adv. 2013, 3, 19830 - 19833.

²⁷ S. R. Lingampalli, U. Gupta, U. K. Gautam, C. N. R. Rao, Oxidation of Toluene and Other Examples of C-H Bond Activation by CdO₂ and ZnO₂ Nanoparticles. ChemPlusChem 2013, 78, 837 - 842.

²⁸ S. Verma, S. L. Jain, Nanosized zinc peroxide (ZnO₂): A novel inorganic oxidant for the oxidation of aromatic alcohols to carbonyl compounds. Inorg. Chem. Front. 2014, 1, 534 - 539.

²⁹ C. N. R. Rao, U. K. Gautam, S. R. Lingampalli, Method of oxidizing an organic compound. 2015, United States Patent (US 8,957,255 B2).

³⁰ N. Uekawa, J. Kajiwara, N. Mochizuki, K. Kakegawa, Y. Sasaki, Synthesis of ZnO Nanoparticles by Decomposition of Zinc Peroxide. Chem. Lett. 2001, 30, 606 - 607.

³¹ P. Rawat, Shalu, R. Nagarajan, Mechanochemical transformation of ZnO₂ to highly defective ZnO. Mater. Lett. 2018, 212, 178 - 181.

³² A. G. Medvedev, A.V. Zhubrikov, E. A. Mel’nik, A. A. Mikhaylov, N. V. Khitrov, T. A. Tripol’skaya, I. V. Shabalova, V. M. Novotortsev, P. V. Prikhodchenko, Stabilization of Zinc Peroxide in the Combined Process of Granulation and Encapsulation. Theor Found Chem Eng 2018, 52, 628 - 633.

³³ (a) M. A. Gondal, Z. H. Yamani, Q. A. Drmosh, A. Rashid, Synthesis of nanostructured ZnO and ZnO₂ by laser ablation process using third harmonic of Nd:YAG laser. Int. J. Nanoparticles 2009, 2, 119 - 128; (b) M. A. Gondal, Q. A. Drmosh, T.A. Saleh, Effect of post-annealing temperature on structural and optical properties of nano — ZnO synthesised from ZnO₂ by laser ablation method. Int. J. Nanoparticles 2010, 3, 257 - 266; (c) Q. A. Drmosh, M. A. Gondal, Z. H. Yamani, T. A. Saleh, Spectroscopic characterization approach to study surfactants effect on ZnO₂ nanoparticles synthesis by laser ablation process. Appl. Surf. Sci. 2010, 256, 4661 - 4666; (d) D. Yang, M. A. Gondal, Z. H. Yamani, U. Baig, X. Qiao, G. Liu, Q. Xu, D. Xiang, J. Mao, K. Shen, 532 nm nanosecond pulse laser triggered synthesis of ZnO₂ nanoparticles via a fast ablation technique in liquid and their photocatalytic performance. Mater. Sci. Semicond. Process. 2017, 57, 124 - 131.

³⁴ E. Ebler, R. L. Krause, Über das Zinkperoxyt (Zinkmoloxyd, Zinkperoxydat), ZnO₂, ½ H₂O und eine allgemeine Methode zur Darstellung von Peroxyten. Z. Anorg. Chem. 1911, 71, 150 -165.

³⁵ E. Redel, S. Petrov, Ö. Dag, J. Moir, C. Huai, P. Mirtchev, G. A. Ozin, Green Nanochemistry: Metal Oxide Nanoparticles and Porous Thin Films from Bare Metal Powders. Small 2012, 8, 68 -72.

³⁶S. Makumire, V. S. K. Chakravadhanula, G. Köllisch, E. Redel, A. Shonhai, Immunomodulatory activity of zinc peroxide (ZnO₂) and titanium dioxide (TiO₂) nanoparticles and their effects on DNA and protein integrity. Toxicol. Lett. 2014, 227, 56 - 64.

³⁷ S. Cheng, D. Yan, J. T. Chen, R. F. Zhuo, J. J. Feng, H. J. Li, H. T. Feng, P. X. Yan, Soft-Template Synthesis and Characterization of ZnO₂ and ZnO Hollow Spheres. J. Phys. Chem. C 2009, 113, 13630 - 13635.

³⁸ Y. Kashiwaba, T. Abe, A. Nakagawa, I. Niikura, Y. Kashiwaba, M. Daibo, T. Fujiwara, H. Osada, Formation of a ZnO₂ layer on the surface of single crystal ZnO substrates with oxygen atoms by hydrogen peroxide treatment. J. Appl. Phys. 2013, 113, 113501.

³⁹ H.-Y. Lee, B.-K. Wu, M.-Y. Chem, Study on the Formation of Zinc Peroxide on Zinc Oxide with Hydrogen Peroxide Treatment Using X-ray Photoelectron Spectroscopy (XPS). Electron. Mater. Lett. 2014, 10, 51 - 55.

⁴⁰ (a) F. M. Simanjuntak, S. Chandrasekaran, C.-C. Lin, T.-Y. Tseng, Switching Failure Mechanism in Zinc Peroxide-Based Programmable Metallization Cell. Nanoscale Res. Lett. 2018, 13, 327; (b) F. M. Simanjuntak, S. Chandrasekaran, C.-C. Lin, T.-Y. Tseng, ZnO₂/ZnO bilayer switching film for making fully transparent analog memristor devices. APL Mater. 2019, 7, 051108.

⁴¹ V. Alvarado-Pérez, L. I. Cabrera-Lara, G. López-Téllez, D. Mendoza-Anaya, S. Hernández-López, M. Camacho-López, ZnO to ZnO₂ transformation assisted by H₂O₂ at ambient conditions. Mater. Chem. Phys. 2019, 233, 180 - 184.

⁴² S. Ghosh, R. Bhattacharyya, H. Saha, C. R. Chaudhuri, N. Mukherjee, Functionalized ZnO/ZnO₂ n-N straddling heterostructure achieved by oxygen plasma bombardment for highly selective methane sensing. Phys. Chem. Chem. Phys. 2015, 17, 27777 - 27788.

⁴³ Y. Saito, T. Shiga, A. Kokubun, T. Kawai, H. Unuma, Preparation of Transparent ZnO Thin Films via ZnO₂ Precursor Deposited from Aqueous Solutions. J Ceram. Soc. Jpn. 2007, 115, 938 - 940.

⁴⁴ M. Sun, W. Hao, C. Wang, T. Wang, A simple and green approach for preparation of ZnO₂ and ZnO under sunlight irradiation. Chem. Phys. Lett. 2007, 443, 342 - 346.

⁴⁵ L. Rosenthal-Toib, K. Zohar, M. Alagem, Y. Tsur, Synthesis of stabilized nanoparticles of zinc peroxide. Chem. Eng. J. 2008, 136, 425 - 429.

⁴⁶ D. Gao, J. Zhang, G. Yang, J. Qi, M. Si, D. Xue, Ferromagnetism Induced by Oxygen Vacancies in Zinc Peroxide Nanoparticles. J. Phys. Chem. C 2011, 115, 16405 - 16410.

⁴⁷ A. Garcia-Ruiz, A. Escobedo-Morales, A. Aguilar, R. Esparza, R. Pérez, Hydrothermally synthesied nanoparticles of zinc peroxide and their structural description. Quimica Hoy: Chemistry Sciences 2011, 4, 24 -28.

⁴⁸ E. Pál, D. Sebök, V. Hornok, I. Dékány, Structural, optical, and adsorption properties of ZnO₂/poly(acrylic acid) hybrid thin porous films prepared by ionic strength controlled layer-by-layer method. J. Colloid Interface Sci. 2009, 332, 173 - 182.

⁴⁹ D. Sebök, T. Szabó, I. Dékány, Optical properties of zinc peroxide and zinc oxide multilayer nanohybrid films. Appl. Surf. Sci. 2009, 255, 6953 - 6962.

⁵⁰ D. Sebök, L. Janovák, I. Dékány, Optical, structural and adsorption properties of zinc peroxide/hydrogel nanohybrid films. Appl. Surf. Sci. 2010, 256, 5349 - 5354.

⁵¹ Y. Wolanov, P. V. Prikhodchenko, A. G. Medvedev, R. Pedahzur, O. Lev, Zinc dioxide nanoparticulates: A hydrogen peroxide source at moderate pH. Environ. Sci. Technol. 2013, 47, 8769 - 8774.

⁵² J.E. Morales-Mendoza, F. Paraguay-Delgado, J.A. Duarte Moller, G. Herrera-Pérez, Nicolaza Pariona, Structure and Optical Properties of ZnO and ZnO₂ Nanoparticles. J. Nano. Res-SW 2019, 56, 49 - 62.

⁵³ A. I. Shames, O. Lev, A. A. Mikhaylov, A. G. Medvedev, J. Gun, P. V. Prikhodchenko, Unusual Stabilization of Zinc Peroxide by Manganese Oxide: Mechanistic Understanding by Temperature-Dependent EPR Studies. J. Phys. Chem. C 2019, 123, 20884 - 20892.

⁵⁴R. A. Pawar, D. R. Shinde, P. S. Tambade. Synthesis of ZnO photocatalyst via ZnO₂ precursor and its application for dye degradation from effluent under solar irradiation. Desalin. Water Treat. 2016, 57, 16514 - 16521.

⁵⁵ P. V.Prikhodchenko, A. G.Medvedev, A. A.Mikhaylov, T. A.Tripol′skaya, L. Cumbal, R. Shelkov, Y. Wolanov, J. Gun, Renewable zinc dioxide nanoparticles and coatings. Mater. Lett. 2014, 116, 282 - 285.

⁵⁶ P. Ganguly, R. K. Kotnala, S. Singh, R. P. Pant, N. Singh, Graphene functionalized with 3-mercatopropionic acid capped zinc peroxide nanoparticles: A potential ferromagnetic material at room-temperature’, Carbon 2015, 95, 428 - 433.

⁵⁷ C. Bergs, P. Simon, Y. Prots, A. Pich, Ultrasmall functional ZnO₂ nanoparticles: synthesis, characterization and oxygen release properties. RSC Adv. 2016, 6, 84777 - 84786.

⁵⁸ M. Elbahri, R. Abdelaziz, D. Disci-Zayed, S. Homaeigohar, J. Sosna, D. Adam, L. Kienle, T. Dankwort, M. Abdelaziz, Underwater Leidenfrost nanochemistry for creation of size-tailored zinc peroxide cancer nanotherapeutics. Nat. Commun. 2017, 8, 15319.

⁵⁹ L. Y. Yang, G. P. Feng, T. X. Wang, Green synthesis of ZnO₂ nanoparticles from hydrozincite and hydrogen peroxide at room temperature. Mater. Lett. 2010, 64, 1647 - 1649.

⁶⁰ L. Liu, T. X. Wang, Y. C. Zhang, M. Zhang, Two-Step Green Hydrothermal Synthesis of ZnO powders. Adv. Mater. Res. 2011, 284-286, 654 - 657.

⁶¹ K.-A. Kim, J.-R. Cha, M.-S. Gong, J.-G. Kim, Preparation of ZnO₂ Nanoparticles Using Organometallic Zinc(II) Isobutylcarbamate in Organic Solvent. Bull. Korean Chem. Soc. 2014, 35, 431 - 435.

⁶² P. Y. Wang, Q. H. Gao, J. Q. Xu, Study of photocatalytic activity of nanosized zinc peroxide. Fine Chemicals 2007, 24, 436 - 439.

⁶³ S. Lindroos, M. Leskelä, Growth of zinc peroxide (ZnO₂) and zinc oxide (ZnO) thin films by the successive ionic layer adsorption and reaction - SILAR - technique. Int. J. Inorg. Mater. 2000, 2, 197 - 201.

⁶⁴ Method for preparing nanometer zinc peroxide particle by metallic organic intermediate body method. 2007. China Patent (CN100562489C).

⁶⁵ H. Morkoç, U. Özgür, Zinc Oxide: Fundamentals, Materials and Device Technology, Willey-VCH, Weinheim, 2009.

⁶⁶ (a) L. Spanhel, M. A. Anderson, Semiconductor Clusters in the Sol-Gel Process: Quantized Aggregation, Gelation, and Crystal Growth in Concentrated ZnO Colloids J. Am. Chem. Soc. 1991, 113, 2826 - 2833; (b) E. A. Meulenkamp, Synthesis and Growth of ZnO Nanoparticles. J. Phys. Chem. B 1998, 102, 5566 - 5572; (c) C. Pacholski, A. Kornowski, H. Weller, Self-Assembly of ZnO: From Nanodots to Nanorods. Angew. Chem. Int. Ed. 2002, 41, 1188 -1191.

⁶⁷ (a) M. Monge, M. L. Kahn, A. Maisonnat, B. Chaudret, Room-Temperature Organometallic Synthesis of Soluble and Crystalline ZnO Nanoparticles of Controlled Size and Shape. Angew. Chem. Int. Ed. 2003, 42, 5321 - 53 24; (b) M. L. Kahn, M. Monge, V. Collière, F. Senocq, A. Maisonnat, B. Chaudret, Size- and Shape Control of Crystalline Zinc Oxide Nanoparticles: A New Organometallic Synthetic Method. Adv. Funct. Mater. 2005, 15, 458 - 468.

⁶⁸ K. L. Orchard, M. S. P. Shaffer, C. K. Williams, Organometallic Route to Surface-Modified ZnO Nanoparticles Suitable for In Situ Nanocomposite Synthesis: Bound Carboxylate Stoichiometry Controls Particle Size or Surface Coverage, Chem. Mater. 2012, 24, 2443 - 2448.

⁶⁹ (a) A. Grala, M. Wolska-Pietkiewicz, W. Danowski, Z. Wrobel, J. Grzonka, J. Lewiński, ‘Clickable’ ZnO Nanocrystals: the Superiority of a Novel Organometallic Approach over the Inorganic Sol-Gel Procedure. Chem. Commun. 2016, 52, 7340 - 7343; (b) E. Chwojnowska, M. Wolska-Pietkiewicz, J. Grzonka, J. Lewiński, An Organometallic Route to Chiroptically Active ZnO Nanocrystals. Nanoscale 2017, 9, 14782 - 14786; (c) M. Wolska-Pietkiewicz, K. Tokarska, A. Grala, A. Wojewódzka, E. Chwojnowska, J. Grzonka, P. Cywiński, K. Kruczala, Z. Sojka, M. Chudy, J. Lewiński, Safe-by-Design Ligand-Coated ZnO Nanocrystals Engineered by an Organometallic Approach: Unique Physicochemical Properties and Low Toxicity toward Lung Cells. Chem. Eur. J. 2018, 24, 4033 - 4042; (d) D. Lee, M. Wolska-Pietkiewicz, S. Badoni, A. Grala, J. Lewiński, G. De Paëpe, Disclosing Interfaces of ZnO Nanocrystals Using Dynamic Nuclear Polarization: Sol Gel versus Organometallic Approach. Angew. Chem. Int. Ed. 2019, 25, 17163 - 17168.

⁷⁰ (a) C. G. Kim, K. Sung, T.-M. Chung, D. Y. Jungb Y. Kim, Monodispersed ZnO Nanoparticles from a Single Molecular Precursor. Chem. Commun. 2003, 2068 - 2069; (b) V. Ischenko, S. Polarz, D. Grote, V. Stavarache, K. Fink, M. Driess, Zinc Oxide Nanoparticles with Defects. Adv.Funct. Mater. 2005, 15, 1945 - 1954; (c) S. Polarz, J. Strunk, V. Ischenko, M. W. E. van den Berg, O. Hinrichsen, M. Muhler, M. Driess, On the Role of Oxygen Defects in the Catalytic Performance of Zinc Oxide. Angew. Chem. Int. Ed. 2006, 45, 2965-2969; (d) K. Sokolowski, I. Justyniak, W. Bury, J. Grzonka, Z. Kaszkur, L. Makolski, M. Dutkiewicz, A. Lewalska, E. Krajewska, D. Kubicki, K. Wojcik, K. J. Kurzydlowski, J.; Lewinski, tert-Butyl(tertbutoxy)zinc Hydroxides: Hybrid Models for Single-Source Precursors of ZnO Nanocrystals. Chem. Eur. J. 2015, 21, 5488 - 5495.

1. A method of preparation of zinc-oxygen-based nanoparticles, in which an organozinc precursor is treated with an oxidizing agent, characterized in that the organozinc precursor is a compound of the formula (R)ₙ(Zn)ₘ(L)_{y}(X)_{z} wherein
R is at least one subset of a set comprising straight, branched, and cyclic C1-C10 alkyl groups, straight, branched, and cyclic C1-C10 alkenyl groups, a benzyl group, a phenyl group, and a mesityl group, wherein any hydrogen atom can be substituted with at least one subset of a set comprising fluorine, chlorine, bromine and iodine atoms, and wherein
L is a neutral donor organic ligand selected from the group of organic compounds including at least one subset of a set comprising amine, phosphine, phosphine oxide, sulfoxide, ketone, amide, imine, ether, urea and related organic derivatives, aminosilane or perfluorinated derivatives thereof, and mixtures thereof, and wherein
X is monoanionic organic ligand derived from the organic compound X-H, wherein H is a hydrogen atom with acidic properties and the compound X-H is at least one of a set comprising carboxylic acid, amide, amine, imide, alcohol, mono- or diester of phosphoric acid, organic derivatives of phosphinic or phosphonic acid, phenol, mercaptan, hydroxy acid, amino acid, hydroxy amide, amino amide, hydroxy ester, amino ester, hydroxy ketone, amino ketone, urea and its organic derivatives, silanol, aminosilane, mercaptosilane and organic derivatives of alkoxysilane or perfluorinated derivatives thereof, and a mixtures thereof, and wherein
m and n are integers from 1 to 10, and wherein
y and z are integers from 0 to 10, and wherein
the oxidizing agent is at least one of hydrogen peroxide, peracetic acid, and ozone, and wherein
the organozinc precursor is treated with the oxidizing agent under an inert gas atmosphere.

2. The method of claim 1 characterized in that at least one of a set comprising achiral, optically active, and organic compounds with an additional positive charge located at at least one of a set comprising nitrogen (N), phosphorus (P), and sulfur (S) atoms are used as L- and X-type ligands.

3. The method of claim 1 characterized in that at least one of a set comprising zinc peroxide (ZnO₂) nanoparticles and zinc oxide (ZnO) nanoparticles are prepared.

4. The method of claim 1 characterized in that uncoated zinc-oxygen-based nanoparticles are prepared.

5. The method of claim 1 characterized in that zinc-oxygen-based nanoparticles are coated with an organic shell composed of at least one organic ligand selected from X and L, preferably zinc-oxygen-based nanoparticles coated with an organic shell composed of two or more organic ligands selected from X and L.

6. The method of claim 1 characterized in that zinc-oxygen-based nanoparticles with a diameter less than or equal to 5 nm are prepared.

7. The method of claim 1 characterized in that at least one of a set comprising dialkyl- and diarylzinc compound of the formula R₂Zn, wherein R is at least one subset of a set comprising straight, branched, and cyclic C1-C10 alkyl group and straight, branched, and cyclic C1-C10 alkenyl group, a benzyl group, a phenyl group, and a mesityl group, in which any hydrogen atom may be substituted with at least one of a set comprising fluorine, chlorine, bromine, and iodine atoms is used as organozinc precursor.

8. The method of claim 1 characterized in that the organozinc precursor is a compound produced by the reaction between at least one of a set comprising dialkyl- and diarylzinc compound of the formula R₂Zn and an organic L- or X-H-type compound, and a mixture of two or more of these compounds, wherein:
R is at least one subset of a set comprising straight, branched, and cyclic C1-C10 alkyl group, straight, branched or cyclic C1-C10 alkenyl group, a benzyl group, a phenyl group, and a mesityl group in which any hydrogen atom may be substituted with at least one of a set comprising fluorine, chlorine, bromine, and iodine atoms;
L is at least one of a set comprising amine, phosphine, phosphine oxide, sulfoxide, ketone, amide, imine, ether, urea and its organic derivatives, aminosilane or perfluorinated derivatives thereof, and mixtures thereof; and
X-H is a at least one of a set comprising carboxylic acid, amide, amine, imide, alcohol, mono- or diester of phosphoric acid, organic derivatives of phosphinic or phosphonic acid, phenol, mercaptan, hydroxy acid, amino acid, hydroxy amide, amino amide, hydroxy ester, amino ester, hydroxy ketone, amino ketone, urea and its organic derivatives, silanol, aminosilane, mercaptosilane and organic derivatives of alkoxysilane or perfluorinated derivatives thereof, and mixtures thereof.

9. The method of claim 8 characterized in that at least one of a set comprising homoligand precursor or a heteroligand precursor and mixtures thereof is used as organozinc precursor.

10. The method of claim 8 characterized in that at least one of a set comprising diethylzinc, dimethylzinc, di-iso-propylzinc, di-tert-buthylzinc, dicyclopentylzinc, dicyclohexylzinc and dicyclopentadienylzinc are used as dialkylzinc compound.

11. The method of claim 8 characterized in that at least one of a set comprising diphenylzinc and bis (pentafluorophenyl) zinc is used as a diarylzinc compound.

12. The method of claim 1 characterized in that hydrogen peroxide in the form of at least one of a set comprising an aqueous solution and in the form of a solid-state peroxide adduct is used as an oxidizing agent, preferably hydrogen peroxide in the form of the aqueous solution at a concentration in the range from 1 to 75% is used, more preferably hydrogen peroxide in the form of the aqueous solution at a concentration in the range from 3 to 30% is used, most preferably hydrogen peroxide in the form of the aqueous solution at the concentration of 30% is used.

13. The method of claim 12 characterized in that at least one of a set comprising hydrogen peroxide-urea adduct (CO(NH₂)₂·H₂O₂) and sodium percarbonate (Na₂CO₃·1.5H₂O₂) is used as a peroxide adduct.

14. The method of claim 1 characterized in that a molar ratio of the organozinc precursor to the oxidizing agent ranges from 1:1 to 1:4 is used, preferably the molar ratio of the organozinc precursor to the oxidizing agent equals 1:1 is used.

15. The method of claim 1 characterized in that the organozinc precursor is treated with the oxidizing agent in an aprotic organic solvent or the reaction is carried out by a mechanochemical, i.e., solvent-free approach.

16. The method of claim 15 characterized in that anhydrous or water-containing solvent is used as an aprotic organic solvent, preferably at least one of a set comprising anhydrous and water-containing solvent is used as aprotic organic solvent, wherein with respect to the water-containing solvent, the preferably concentration of water in the solvent is less than 0.5%.

17. The method of claim 16 characterized in that at least one of a set comprising tetrahydrofuran, toluene, xylene, benzene, dimethylsulfoxide, dichloromethane, dioxane, acetonitrile, chloroform, hexane, acetone, diethyl ether, and mixtures thereof are used as aprotic organic solvent.

18. The method of claim 1 characterized in that molar concentration of the organozinc precursor in the reaction mixture ranges from 0.01 mol/L to 0.5 mol/L.

19. The method of claim 1 characterized in that the method is carried out by a mechanochemical, i.e., solvent-free approach.

20. The method of claims 1 wherein zinc peroxide nanoparticles are prepared.

21. The method of claim 20 wherein zinc peroxide nanoparticles are uncoated or coated with an organic shell.

22. The method of claims 21 wherein zinc peroxide nanoparticles are characterized in that the organic shell is composed of at least one organic ligand selected from X and L.

23. The use of zinc peroxide nanoparticles of claims 21 as antibacterial and bacteriostatic materials, or as a component of pyrotechnic compositions, or as photocatalyst, or as single-source inorganic precursors of nanoparticulate forms of zinc oxide (ZnO).
